(19) United States
(12) Patent Application Publication
(10) Pub. No.: US 2026/0095380 A1
(43) Pub. Date: Apr. 2, 2026

(54) EVALUATING QUALITY OF EXPERIENCE IN MESH NETWORKS

(71) Applicant: Spirent Communications, Inc., San Jose, CA (US)

(72) Inventors: Janne Linkola, Lexington, MA (US); Edwin Shearer, Pleasanton, CA (US)

(73) Assignee: Spirent Communications, Inc., San Jose, CA (US)

(21) Appl. No.: 18/957,087

(22) Filed: Nov. 22, 2024

Related U.S. Application Data
(60) Provisional application No. 63/702,046, filed on Oct. 1, 2024.

(51) Int. Cl. H04L 41/14; H04L 67/131; H04W 24/06

(52) U.S. Cl. CPC H04L 41/145; H04L 67/131; H04W 24/06

(57) ABSTRACT

The technology involves a method, medium, and testbed scoring cloud-application Quality of Experience (“QoE”) by emulating a mesh network at building locations inside of a building. The testbed includes test environment devices comprising test chambers holding respective stations (“STAs”) that run applications, or Access Points (“APs”) coupled in a mesh, respective connective cables between pairs of test environment devices, the cables reproducing attenuation between building locations, and at least one of the APs serving as a gateway to an internet server. QoE scoring includes a controller causing multiple types of applications on the STAs to generate traffic by executing test exchanges with the server. The testbed measures traffic produced by the test exchanges and scores the traffic streams measured for each of the test sequences of exchanges by combining the measurements into traffic stream scores and by combining the traffic stream scores for the application into a cloud-application QoE score.

### PRIORITY APPLICATION

This application claims the benefit of U.S. Provisional Patent Application No. 63/702,046 titled “Evaluating Quality of Experience in Mesh Networks,” filed 1 Oct. 2024 (Attorney Docket 1176-1), which is incorporated by reference.

### RELATED APPLICATIONS

This application is related to the following commonly owned applications which are incorporated by reference herein:

U.S. patent application Ser. No. 18/817,156 titled “Method and System for End-to-End Calibration of a Channel Emulator,” filed 27 Aug. 2024 (Attorney Docket No. SPIR 1178-1); and

U.S. patent application Ser. No. 18/913,993 titled “Self Calibrating Testbed,” filed 11 Oct. 2024 (Attorney Docket No. SPIR 1177-1).

### FIELD OF TECHNOLOGY

This technology relates, generally, to wireless and Wi-Fi field-to-lab testing. More specifically, the technology relates to testing application performance of cloud applications on a mesh network, from a building location. The technology also relates to testing application performance in a network with multiple access points and multiple stations.

### ACRONYMS

Acronyms used in this disclosure are identified the first time that they are used. These acronyms are terms of art, often used in standards documents. Except where the terms and phrases are used in a clear and distinctly different sense than they are used in the art, we adopt the meanings found in testing standards. For the reader's convenience, many of them are listed here:

| Acronym | Phrase |
|---|---|
| AP | Access Point |
| CRM | Computer Readable Medium |
| EPL | Effective Packet Loss |
| FPS | Frames Per Second |
| IoT | Internet of Things |
| MU- | multi-user, multiple input, multiple output |
| MIMO | |
| OFDMA | Orthogonal frequency-division multiple access |
| OWD | One Way Delay |
| PCAP | Packet Capture |
| PTP | Precision Time Protocol |
| QoE | Quality of Experience |
| STA | Station |
| RSSI | Received Signal Strength Indicator |
| RTT | Round-Trip Time |
| VBR | Variable Bitrate |
| VOD | Video on Demand |
| XR/VR | Extended Reality or Virtual Reality |

### BACKGROUND

The following detailed description is made with reference to the figures. Example implementations are described to illustrate the technology disclosed, not to limit its scope, which is defined by the claims. Those of ordinary skill in the art will recognize a variety of equivalent variations on the description that follows.

The testing industry has recognized the need for wireless testing that better represents complex networks. Wi-Fi Alliance™ has published a test plan that uses multiple access points and multiple stations in their Device Metrics® test plan hxxps://www.wi-fi.org/file/wi-fi-device-metrics. This test plan takes a statistical view of test results and the tests described are relatively traditional scenarios. There have been discussions about how to create a new test plan that emulates several simultaneous users running a variety of different applications in a typical home. Thus far, the industry has found difficulty in implementing such a test plan due to the complexity of representing the network and representing the results based on isolated measurements.

Furthermore, even when traditional approaches to testing are applicable, many users often do not understand the reported measurements. Those users care more, for instance, about whether they can watch Netflix streams on the bedroom cloud-capable television and less about performance indications such as throughput, latency, etc.

An opportunity arises for technology that provides complex testing and simple reporting.

### BRIEF DESCRIPTION OF THE DRAWINGS

The patent or application file contains at least one drawing executed in color. Copies of this patent or patent application publication with color drawings will be provided by the Office upon request and payment of the necessary fee.

The color drawings also typically are available in the Patent Center supplemental content tab.

FIGS. 1A and 1B, collectively referred to as FIG. 1, illustrate a testbed diagram of an example wireless device testbed that emulates a wireless network.

FIG. 1A defers reference numbering of attenuators in block diagram 100 to FIG. 1B.

FIG. 1B illustrates a testbed with attenuators connecting test chamber pairs and connecting test chamber-emulation pairs.

FIG. 2 illustrates a test environment with the wireless testbed.

FIG. 3 illustrates a floor plan of a home.

FIG. 4 illustrates the floor plan for the home with Access Points in a mesh network.

FIG. 5 illustrates the block diagram of the testbed with Access Points emulating the mesh network.

FIG. 6 illustrates the floor plan with a wireless device on the front porch.

FIG. 7 illustrates the block diagram of the testbed emulating the wireless device on the front porch.

FIG. 8 illustrates the floor plan with another wireless device at the verandah.

FIG. 9 illustrates the block diagram of the testbed emulating the wireless device at the verandah.

FIG. 10 illustrates the floor plan with the mesh network serving a moving station that traverses a path through the home.

FIG. 11 illustrates the block diagram of the testbed simulating the moving station.

FIG. 12 illustrates a table of application types, traffic streams associated with those application types, and measurements of those traffic streams.

FIGS. 13A, 13B and 13C collectively referred to as FIG. 13, illustrate thresholded normalized scoring for two scoring measurements of One Way Delay.

FIG. 13A illustrates a plot of cumulative distribution function of One Way Delay.

FIG. 13B illustrates a thresholded normalized scoring plot of mean One Way Delay.

FIG. 13C illustrates a thresholded normalized scoring plot of One Way Delay 99.7th percentile.

FIG. 14 illustrates a table of traffic streams associated with application types, and traffic stream scoring based on measurement scores, and Quality of Experience scoring based on the traffic stream scores.

FIG. 15 illustrates a table of example canned traffic profiles, and more examples of Quality of Experience (“QoE”) scoring.

FIG. 16 is a block diagram of an example computer system.

### DETAILED DESCRIPTION

The technology disclosed tests the performance of applications in complex home environments, such as model homes with dozens of wireless devices. Testing an application's quality of experience (“QoE”) substantially improves on the practice of testing raw throughput between a single station (aka wireless device or “STA”) and a single Access Point (“AP”). The technology disclosed uses a testbed with attenuated connections between test environment devices to model complex wireless networking. The testbed includes multiple test environment devices such as test chambers (“test chambers”) holding electromagnetically-isolated wireless mobile devices or access points, and non-test chamber emulated devices. Connective cables equipped with controllable attenuators couple the multiple test environment devices. A testbed controller can adjust attenuators during a test to emulate movement of a mobile device through the model home. The controller causes the test environment devices to generate application traffic that competes for wireless bandwidth. STAs host applications of multiple application types such as gaming, video conferencing, movie or televised streaming, voice over IP, and so forth. The testbed can evaluate users' application QoE in complex home wireless networks, including mesh networks.

Wireless devices in real-world wireless networks select among multiple APs for network access. A real-world home mesh network of moderate complexity includes, for instance, a root AP and two extender APs, with more than 20 STAs accessing the cloud. The STAs could include five smart phones, four wireless tablets, three laptops, two desktops, six entertainment devices, and several Internet of Things appliances such as thermostats, car chargers, remotely controllable ovens and lighting systems. The STAs are vying for Internet access.

Real-world applications have different packet delivery requirements to provide a superior user experience. A telephone application may require at least 95% of packets arrive within 15 milliseconds. Video on Demand (“VOD”) applications are one-way, not interactive, so the download can be adequate when more than 75% of packets for a video stream are delivered within 1000 milliseconds. VOD has separate but similarly flexible requirements for the audio download stream.

The testing industry has found it difficult to test real-world model home conditions. Testers have difficulty extending the traditional single-STA to single-AP test format to emulate wireless networks of multiple APs and multiple STAs in a model home. The number of devices to emulate in a modern network make testing setup a laborious process.

The technology disclosed emulates complex wireless networks, either in home or in another building. The technology emulates the wireless network in the model home by calibrating the testbed to reproduce path losses between wireless devices in the model home. The testbed includes multiple signal sources, including both emulated and non-emulated wireless devices. The testbed reproduces model home path losses by adjusting the attenuators between test environment devices. The path losses vary when a mobile device moves within the home during a test.

The technology disclosed summarizes application performance for applications with different network requirements by providing application QoE scores. The technology tests application performance in the emulated wireless network by way of the testbed. A measurement and scoring engine measures network performance of application traffic streams and scores the application QoE using the measurements of the traffic streams.

In general, scoring starts by scoring stream measurements of each individual stream against one or more requirements for the stream. The requirements are based on the ability of the stream performance to support application functionality. The types of data streams could be, for example, keyboard and mouse input, haptics, video, voice communications.

The general scoring process then uses those scores to score the stream.

Then, creates a QoE score. A user's experience of the application depends on the streams meeting their individual requirements. For example, if video conference software runs on a particular home network has excellent video quality but poor audio quality, the user is likely to experience frustration. The QoE score reflect the impact of any stream that could negate the quality of the user's experience.

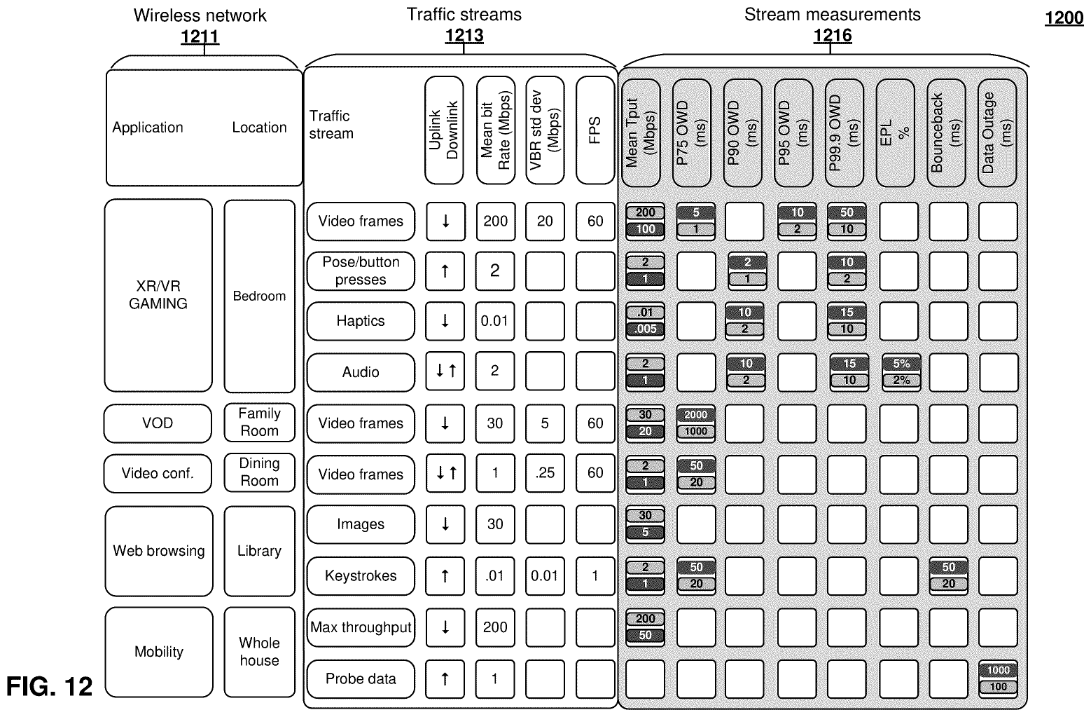

The application QoE score provides an easy-to-understand summarization of how a wireless network affects the user's experience with the application. Application QoE scores can serve as a building block for summarizing the performance of the mesh network in a building or for a scenario. The technology encompasses QoE scoring for a particular cloud application (e.g., Netflix) or a type of application (e.g. video on demand). More details on QoE scores are addressed by FIGS. 12-15 and the corresponding description.

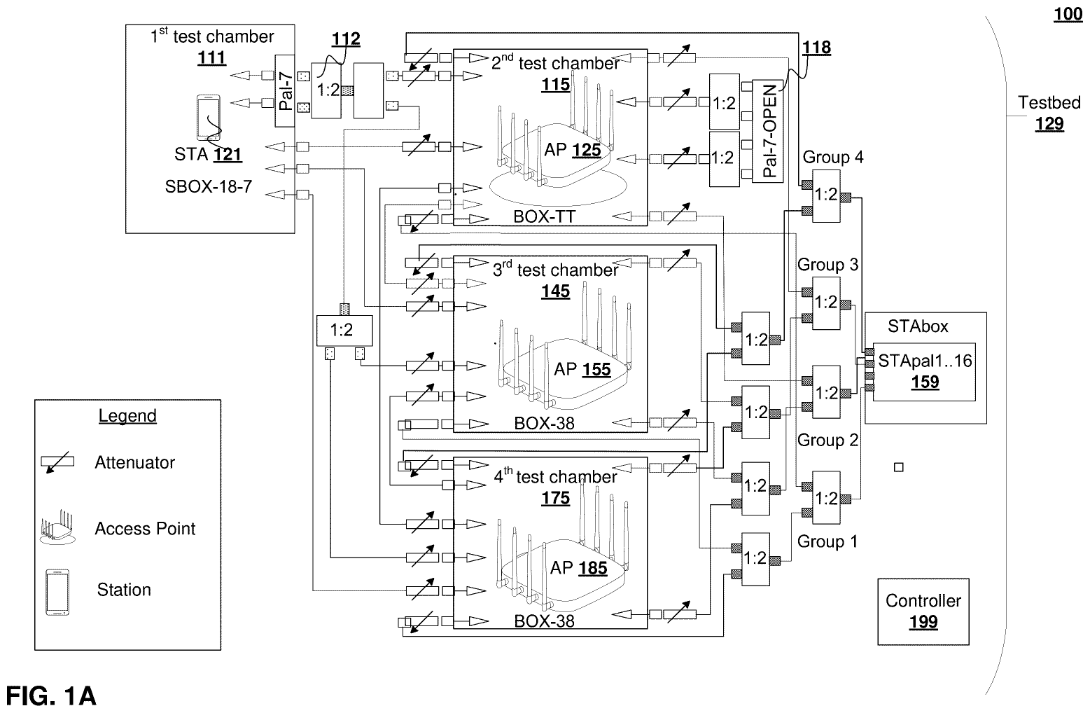

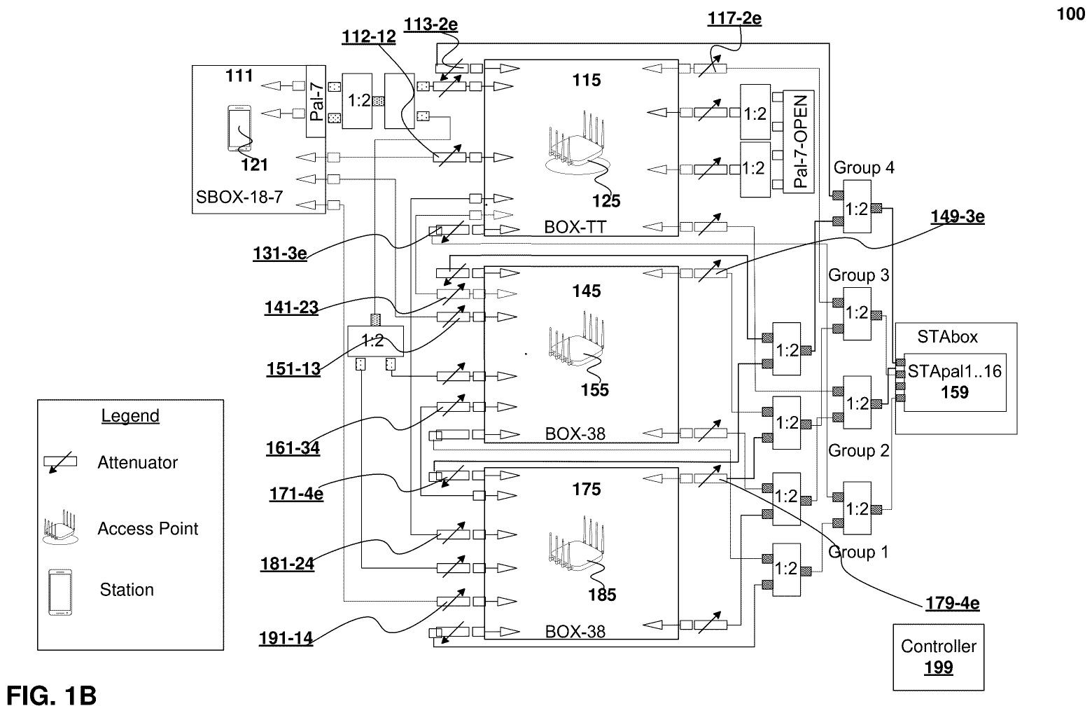

FIGS. 1A and 1B, collectively referred to as FIG. 1, are versions of the same block diagram with attenuator components numbered in FIG. 1B. Both versions illustrate in block diagram 100 an example wireless device testbed 129 that creates a wireless network with path loss that emulates a model environment. Testbed 129 uses the emulated wireless network to perform QoE scoring. In the illustrated testbed, there are four electromagnetically isolated test chambers, a controller, emulators for multiple wireless devices, and connective cables between the test chambers and emulators. Although FIG. 1 illustrates the connections between test chambers or between a test chamber and an emulator, the block diagram omits connections to the controller for the sake of clarity. The connective cables, for instance between test chambers and emulators/other test chambers, include an attenuator with a diagonal arrow and a measurement device. In testbed 129, these components of the connective cable are connected to the controller for signal measurement and attenuation control. Each of the test chambers includes antennas represented by triangles inside test chamber boxes. Three of the test chamber boxes hold access points, and the remaining test chamber holds a wireless device. The number of test chambers and emulators, as well as whether test chambers and emulators are coupled by connective cable, can vary to accommodate a specific test.

FIG. 1A defers reference numbering of attenuators in block diagram 100 to FIG. 1B. The figure illustrates a testbed with test chambers containing a wireless device (aka station or “STA”) and access points (“APs”). Block diagram 100 is a system in a test environment that includes first through fourth electromagnetically-isolated test chambers 111, 115, 145 and 175. Testbed 129 includes STA 121 and access points 125, 155 and 185 positioned in the test chambers. Also shown are emulators and sniffers 112, 118 and 159, and controller 199.

FIG. 1B illustrates the same testbed with labeled attenuators connecting test chamber pairs and connecting test chamber-emulation pairs. Block diagram 100 includes attenuators 112-12, 151-13, 191-14, 141-23, 181-24, 161-34, 113-2e, 117-2e, 131-3e, 149-3e, 171-4e and 179-4e. The reference numbers of the attenuators end with an index value describing the pair of test chambers associated with the attenuator (e.g. 151-13 refers to the first and third chambers and ‘e’ in the index refers to one of the emulated groups).

In FIG. 1, block diagram 100 is a system in a test environment that includes a plurality of electromagnetically isolated test chambers. The illustrated test chambers include first test chamber 111, second test chamber 115, third test chamber 145 and fourth test chamber 175. The testbed also includes a plurality of attenuators.

Testbed 129 includes station STA 121 in the first test chamber. The second through fourth test chambers hold APs 125, 155, 185.

The testbed includes a variety of emulators. Suitable emulators and packet sniffers in the OCTOBOX® PAL® family include PAL-7 112, PAL-7-Open 118 and STApal-7 159. The testbed can use earlier and later versions (e.g., -6 and -8) instead. The PAL® family can perform a variety of emulation and measurement tasks. The PAL-7, for instance, functions as Wi-Fi traffic endpoints or OCTOBOX® Synchrosniffer® probes for performance testing and expert analysis of Wi-Fi devices. The PAL-7 can be used as a traffic generator end point (WAN or LAN) to enable high throughput measurement scenarios (3 Gbps+). Separated traffic and management ports can enable simultaneous measurement and data visualization. Pal-7 also implements up to 256 vSTAs. The Pal-7 can operate as a standalone unit or can be built into an OCTOBOX® chamber, making that chamber a Smartbox®. The datasheet titled OCTOBOX® Pal-7 (May 3, 2024) provides additional details and is incorporated by reference. See also U.S. Pat. No. 10,897,319, “Integrated wireless communication test environment,” which is incorporated by reference. The STApal-7, for instance, functions as Wi-Fi traffic endpoints or OCTOBOX® Synchrosniffer® probes. PAL-7 time-synchronizes Synchrosniffer® probes using Precision Time Protocol (PTP). Packet capture information from the Synchrosniffer® probes can be combined into a single file, with packets captures synchronized by PTP timestamps. A STApal-7 can function as an off-the-shelf device or as a precision test instrument. It can monitor and plot Received Signal Strength Indicator (“RSSI”), data rate, number of spatial streams, channel width and other physical layer information. With a PalBOX®, a testbed can generate Orthogonal frequency-division multiple access (“OFDMA”) and multi-user, multiple input, multiple output (“MU-MIMO”) traffic simultaneously, plus traffic load from up to 96 virtual stations. More details are provided in the datasheet OCTOBOX® STApal-7 (Jul. 30, 2024) which is incorporated by reference. Testbed 129 can include so-called “Open” versions of the PAL® and STApal® devices outfitted with antennas and that function as a Synchrosniffer® or as traffic endpoints, as described in the datasheets.

Testbed 129 also includes controller 199. The controller sets up the testbed and conducts tests. The controller is connected to attenuators, emulators and devices within chambers. The controller sets up the testbed by starting the wireless devices and AP, by configuring the APs to setup the mesh network, and by configuring the wireless devices to generate test traffic. The controller conducts tests by causing the applications to generate traffic with cloud server.

Test chambers first 111, 115, 145 and 175 are connected to one another. The pairs of test chambers are connected by a connective cable configured with an attenuator. Testbed 129, for example, connects first test chamber 111 and second test chamber 115 by a cable configured with attenuator 112-12.

First test chamber 111 is, for instance, an 18-inch-wide chamber that contains STA 121. First test chamber 111 is physically coupled with emulator 112. An OCTOBOX® chamber that is suitable as first test chamber 111 is an 18-inch-wide chamber. A suitable emulator and packet sniffer is a PAL-7. Second test chamber 115 includes a turntable that rotates the contained AP. Here, second test chamber 115 contains AP 125, and a packet sniffer and emulator 118. A suitable packet sniffer and emulator is a PAL-7 OPEN. Third test chamber 145 is a 38-inch-wide chamber that contains AP 155. Fourth test chamber 175 is, for instance, another 38-inch-wide chamber that contains AP 185. Test chambers can also involve OTA coupling or galvanic (soldered) connection to a wireless device antenna.

STA 121, and APs 125, 155 and 185 are tangible wireless devices that comply with the Wi-Fi 802.11 standard or a subsequently developed standard. The wireless devices typically also have cellular and/or Bluetooth® radios.

Emulators and sniffers 112, 118 and 159 can emulate wireless devices that operate in accordance with 802.11 standards. Examples of wireless devices include, and are not limited to cell phones, laptops, tablets and Internet of Things appliances. The emulators also can emulate servers providing services on the Internet. This example uses PAL® emulators from OCTOSCOPE®. In this example implementation, STApals 159 emulate wireless devices. STApals 159 are provided in four groups, with four STApals per group. The splitters for STApal groups 1 through 4 transit signals to second through fourth test chambers 115, 145 and 175. The sniffers sniff packets from the network and provide the packets to external evaluation engines for filtering and measuring. These external evaluations provide information used for application QoE scoring.

Attenuators 112-12, 151-13, 191-14, 141-23, 181-24, 161-34, 113-2e, 117-2e, 131-3e, 149-3e, 171-4e and 179-4e reduce the power of signals sent along their respective connective cables without distorting the waveform. During testbed calibration, controller 199 adjusts the attenuators such that the signals sent along the respective connective cables undergo a path loss required by the test. The path loss is precise even when the signal transits an OTA gap within one of the test chambers. Details regarding adjusting the attenuators for a specific path can be found in the “Self-Calibrating Testbed” application referenced above and incorporated by reference.

Variations of testbed 129 can use separate devices for emulators and packet sniffers. In testbed variations, test chambers other than the specific test chambers listed above, emulators that are not PALs or packet sniffers that are not PALs can be used for isolating wireless devices, emulating, or sniffing. Wireless device emulation can be omitted if the testbed has sufficient numbers of test chambers and physical wireless devices to emulate the wireless network. This disclosure encompasses testbed variations of more or fewer test chambers and different numbers of STAs and APs than shown in FIG. 1.

Testbed 129 does not show a fully connected graph because the STAbox hosting STApals 159 (and all emulation groups driven by STApals 159) is not directly connected to first test chamber 111. Testbed variations can include fully connected test chambers and emulator groups. Although the example includes a single STA and three APs, in testbed variations, the number of STAs and the number of APs can be any whole numbers. The term “whole numbers” includes zero since, as mentioned above, emulators can emulate wireless devices. Although the example only describes emulating STAs at STApals 159, STAs can also be emulated by other emulators. Pal-7 112 could, for example, emulate a STA in lieu of including STA 121 in first test chamber 111.

The example uses wireless devices that are compliant with 802.11 standards. In variations, testbed 129 can self-calibrate and test other wireless technologies. The APs, for example, can be replaced with eNodeBs, and the self-calibration can model cellular network environments using cellular protocols. Testbed variations can also test Bluetooth® communications between wireless devices using Bluetooth-capable equipment and Bluetooth® protocols. The technology encompasses self-calibration and testing for other wireless technologies beyond wireless, cellular, or Bluetooth®.

The illustrated example uses an OCTOBOX® testbed with PAL® emulators. Variations can use other electromagnetically-isolated test chambers and other emulators.

The above variations are not exhaustive, and serves as a non-limiting guide to those skilled in the art.

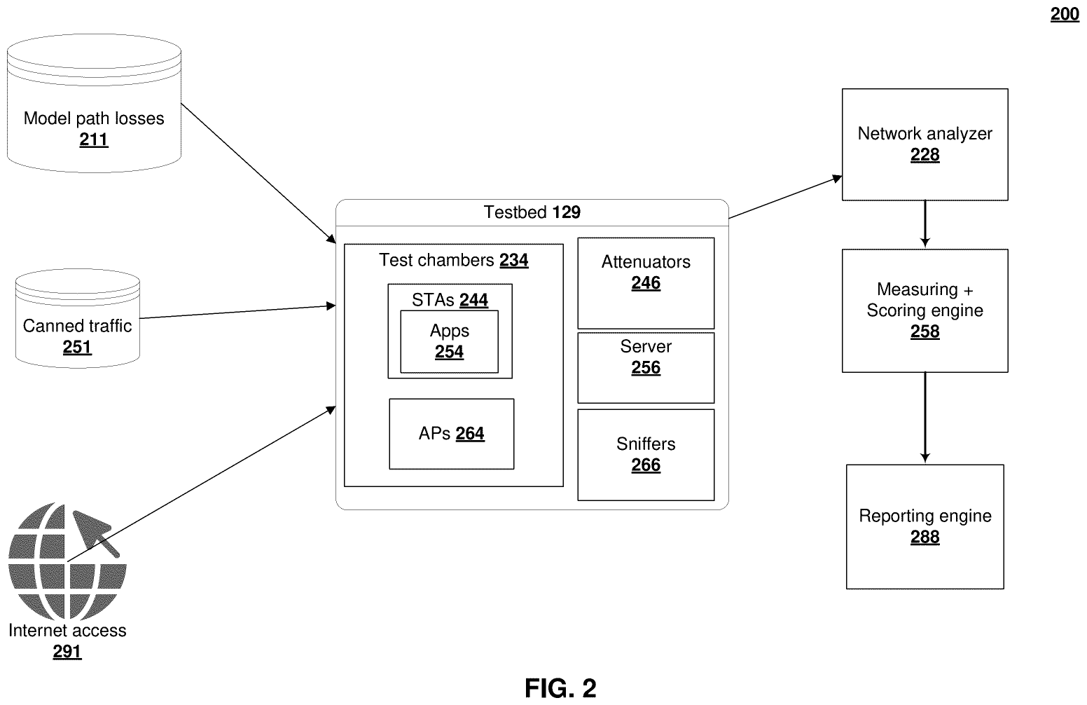

FIG. 2 illustrates a test environment 200 with the wireless testbed. FIG. 1 previously introduced wireless testbed 129. Here in FIG. 2, individual components of testbed 129 include stations (aka wireless devices or “STAs”) 244, apps 254, access points (“APs”) 264, attenuators 246, and sniffers 266. Testbed 129 also shows server 256.

The test environment performs testbed calibration on testbed 129 using model path losses 211. Model path losses storage 211 holds path loss parameters for paths between locations in a model building, such as a model home. Calibration involves adjusting attenuators 246 such that signals sent between test chambers 234 are subject to the same path losses as signals sent between the building locations.

The testbed then tests applications by causing apps 254 and simulated cloud services on server 256 to generate traffic to and from each other. The traffic includes test sequences of exchanges based on stored traffic profiles from canned traffic 251. A traffic profile can be derived from prior exchanges or formulated for test purposes. A test profile can specify the application to be invoked and traffic for the application to generate. For emulated devices, it can include packet traffic to be used during the test. Additionally or alternatively, internet access 291 can provide authentic internet traffic from an authentic cloud service. Tests that involve authentic cloud services hosted on the Internet can also introduce complications and delays beyond those reproduced by the emulated wireless network itself.

Sniffers 266 capture the generated traffic into packet capture (“PCAP”) files. These PCAP capture files are analyzed to generate application QoE scores. When the sniffers 266 in testbed 129 are Pal-7s, they provide synchronized timestamps in the PCAP files using Synchrosniffing technology. Variant testing environments without PALs can employ other approaches to timestamp synchronization and desynchronization detection (e.g., synchronization of all device clocks before placement into the test chambers, comparing bounceback times with device clock values to detect unsynchronized clocks, etc.). The sniffers provide the PCAP files to network analyzer 266.

Network analyzer 228 separates captured packets into traffic streams for applications. A video conferencing application, for example, can have traffic streams for video, audio, and text chat. Network analyzer 288 can filter the packets from the video streams, audio streams, and text chat streams for the video conferencing application, as well as separate those traffic streams from various traffic streams of other applications. Network analyzer 228 can be Wireshark or any other network analyzer that can filter by traffic streams. Other examples of network analyzers are tcp-dump, tshark, Microsoft Message Analyzer, and NetworkMiner.

Measurement and scoring engine 258 measures the separate traffic streams for an application. Measurements can include network performance measurements such as throughput, effective packet loss, packet delay (aka latency), and server responsiveness. Examples of packet delay measurements can include One Way Delay (“OWD”) and Round-trip time (“RTT”). Server responsiveness can be tested using an iPerf bounceback test. Measurement and scoring engine 258 correlates tests and packet timestamps. It produces application QoE scores. These measurements are merely examples, and do not limit the disclosure. Measurement and scoring engine 258 can perform a great many different measurements.

Throughput is the number of received bytes (which can be determined by ACK packets) divided by time. Packet loss is the difference between sent and received packets. If the sender sends 100 packets and the receiver receives 95, then the effective packet loss is 5 percent. Packet delays are the time taken by packets to arrive at the destination. For OWD, packets are sent from a wireless device to the server.

Effective packet loss combines packet loss and any packets that came too late to be used. If the sender sends 100 packets, the receiver receives 95 packets, and 10 of the received packets arrived after a designated time threshold so the late packets arrived too late to be useful, then the effective packet loss is 85%. For RTT, packets are sent from a wireless device to the server, and then packets are sent back from the server to the wireless device. Bounceback measures the responsiveness of a server over a network.

Several types of measurements, including packet delay and bounceback measurements, require synchronized timing on both the STA and server ends of the traffic. The testing environment uses testbed 129 in FIG. 1, sniffers 266 are PALs, which support Synchrosniffing. Synchrosniffing uses Precision Time Protocol to synchronize timestamps in PCAP files. Consequently, testbed 129 can facilitate measurements requiring synchronized timing. In variant testbeds, alternative synchronization protocols can be used, allowing synchronization of wireless device clocks and server 256 clocks. One example approach to clock synchronization for wireless testing in a testbed can be found in Haley et al., U.S. Pat. No. 11,134,456 B2, which is incorporated by reference herein.

Measurements can also include event timing. Handoff, for example, involves transferring an ongoing connection to a STA from one AP to another AP. The measurements can include a difference in time between when handoff procedure started and when the new connection is completed and whether the APs transferred the connection as expected.

Measurement and scoring engine 258 scores the traffic streams for the application. Measurement and scoring engine 258 measures the different traffic streams of the application using network performance measurements. More than one measurement can be applied to a particular traffic stream. Measurement and scoring engine 258 scores the traffic streams based on measurement scores.

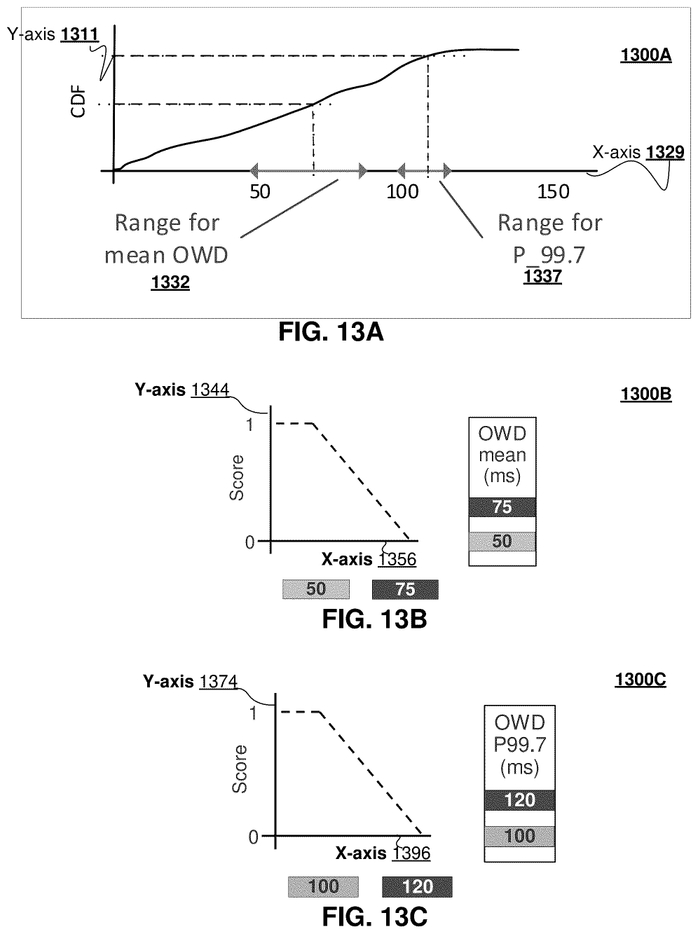

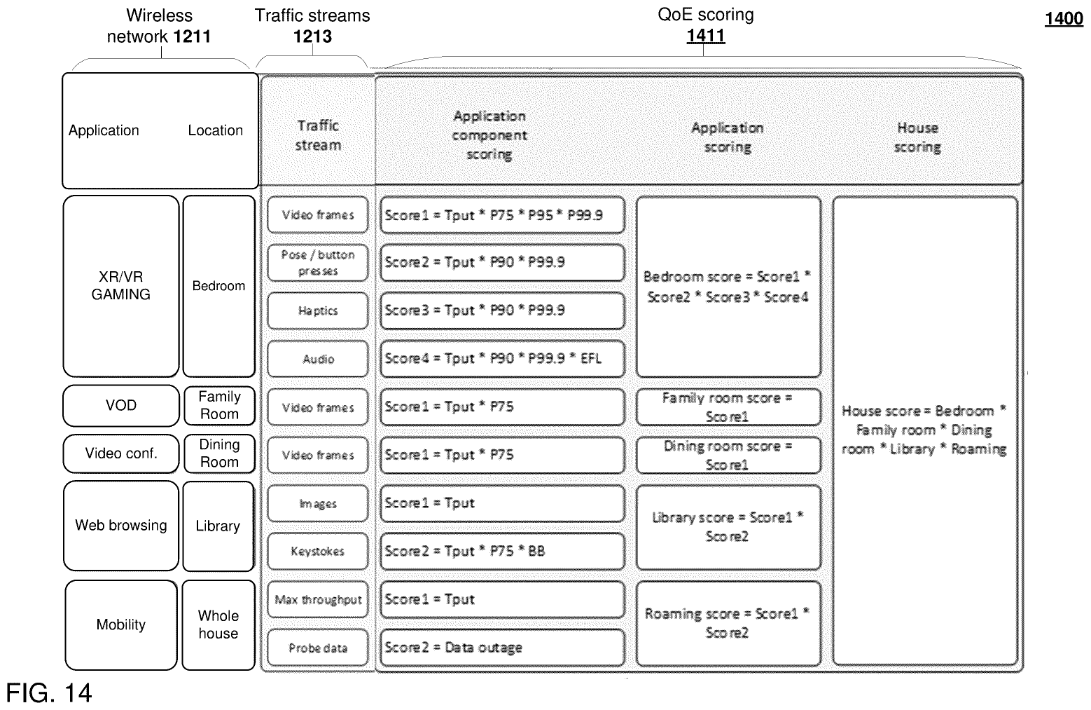

Measurement and scoring engine 258 scores the measurement by comparing the measurements with respective application performance requirements. Examples of performance requirements are provided below with reference to FIG. 12. Examples of measurement scoring are provided below with reference to FIG. 13. Examples of traffic stream scoring and QoE scoring are provided below with reference to FIG. 14.

Application QoE scores, in themselves, provide an easy-to-understand summarization of how a wireless network affects the user's experience with the application in a way that network performance measurements do not. Lay users can be baffled by “throughput” and “latency” and struggle to relate those measurements to a practical comparison. Lay users might not understand what is being measured, and what numbers constitute excellent performance instead of poor performance. However, most lay users can understand that a mesh network's “Netflix score” or a “video on demand” score of 93 beats a comparable score of 87.

The application QoE scores can additionally serve as a building block for other summarizations. In some further variations, application QoE scores from STAs 244 in various building locations can be combined into a building score that summarizes emulated wireless network within the building. In even further variations, the testbed can perform multiple tests of model buildings and emulated wireless networks with many STAs, many APs, hosting applications with high bandwidth demands, large coverage area, etc. Building scores with common scenario characteristics can be combined into a scenario score.

Reporting engine 288 reports at least the application QoE scores. Reporting engine 288 can also report traffic stream scores, building scores, scenario scores, traffic stream measurements. Furthermore, reporting engine 288 can provide network reporting information packet path information, event information (such as time of handoff), whether traffic streams used a preferred band, AP traffic load, and other information of interest in network testing or performance testing of network-connected devices. The network reporting information can be determined by monitoring STAs 244, APs 264 or server 256, or can be derived from the determined network information.

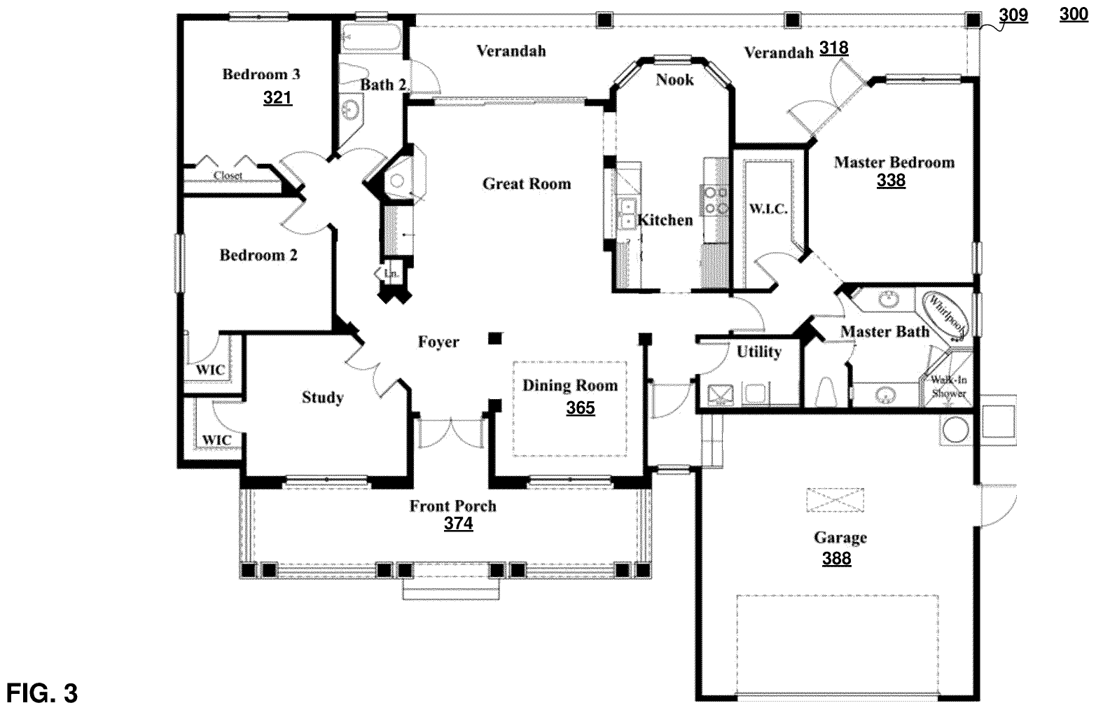

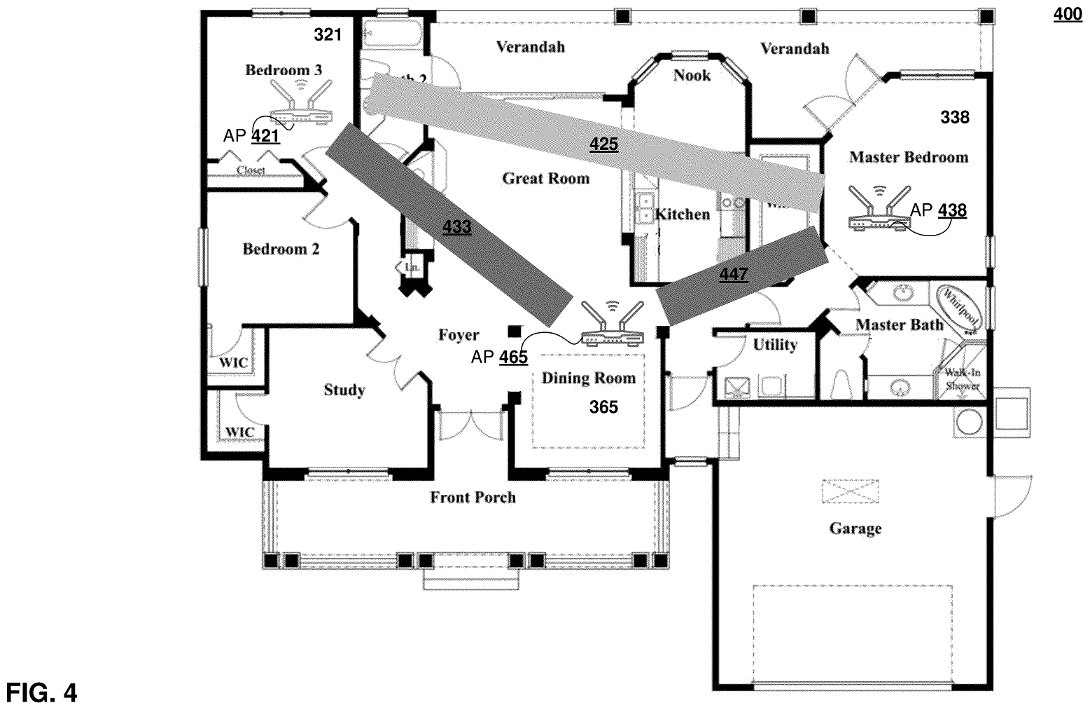

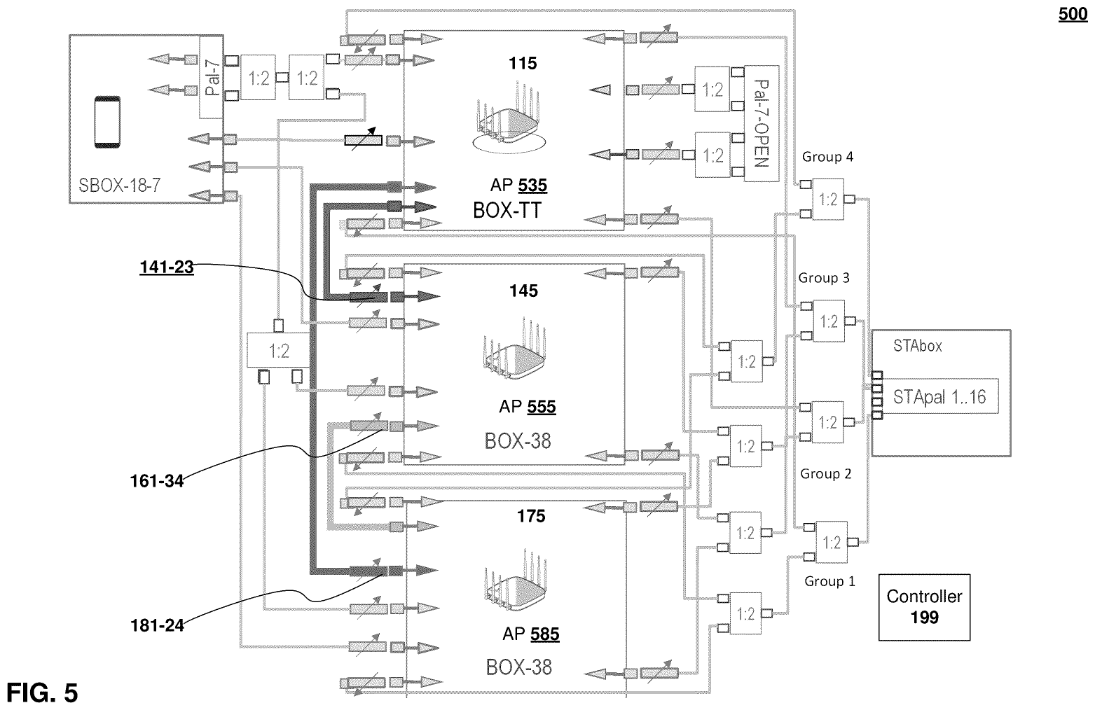

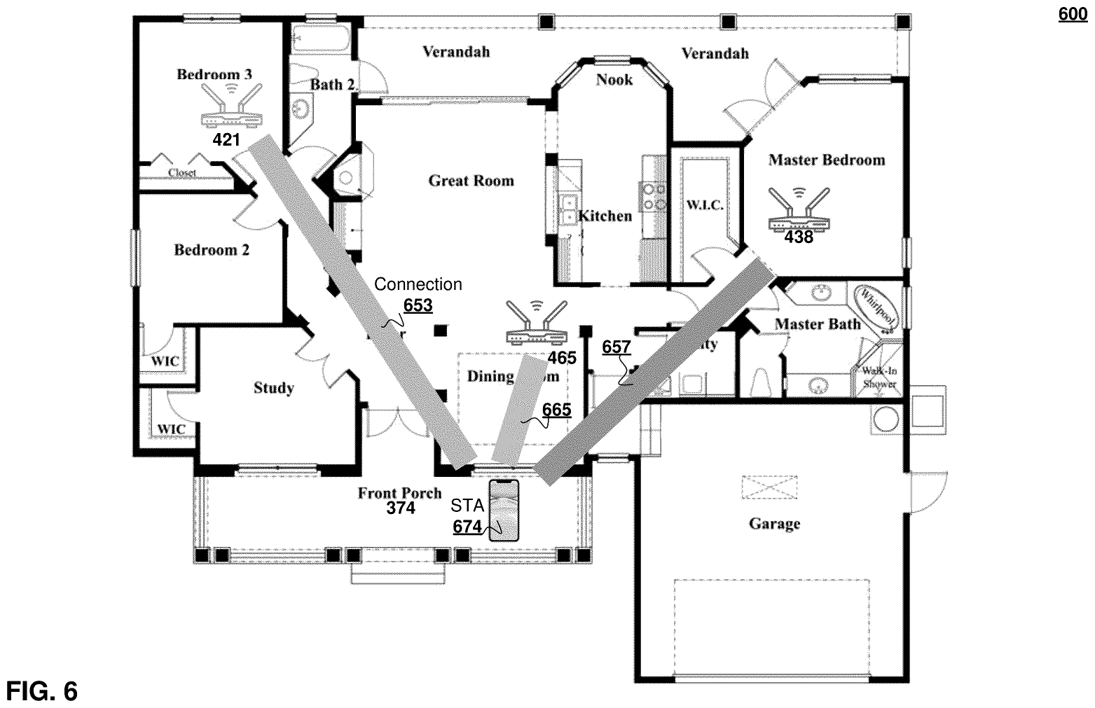

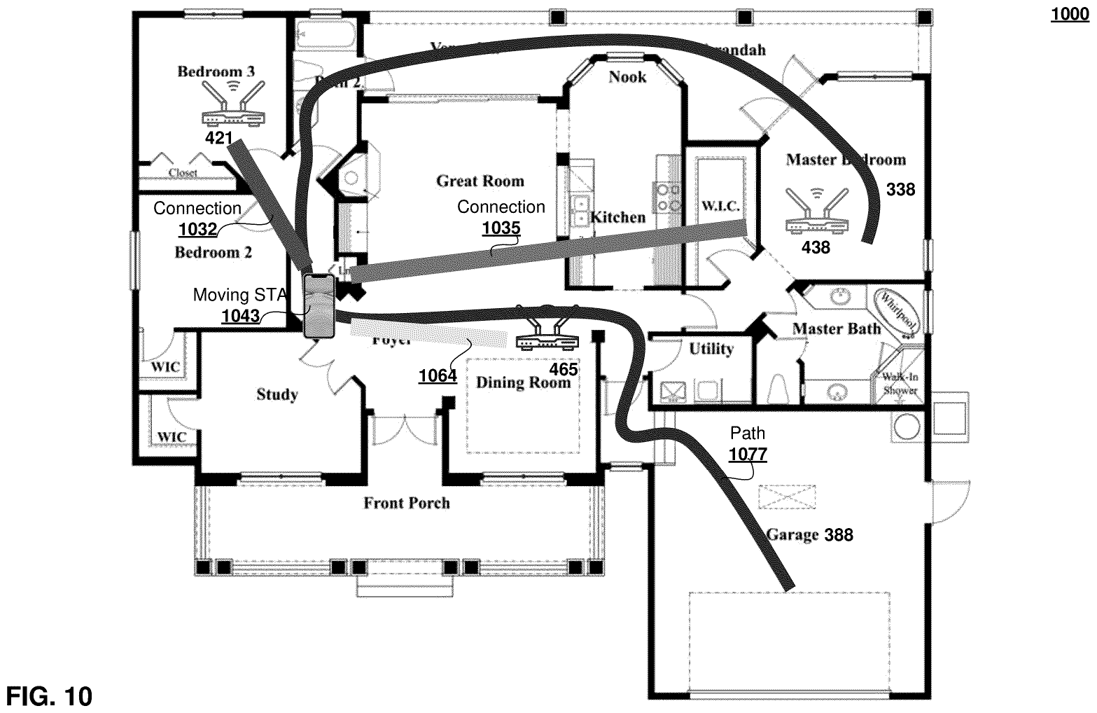

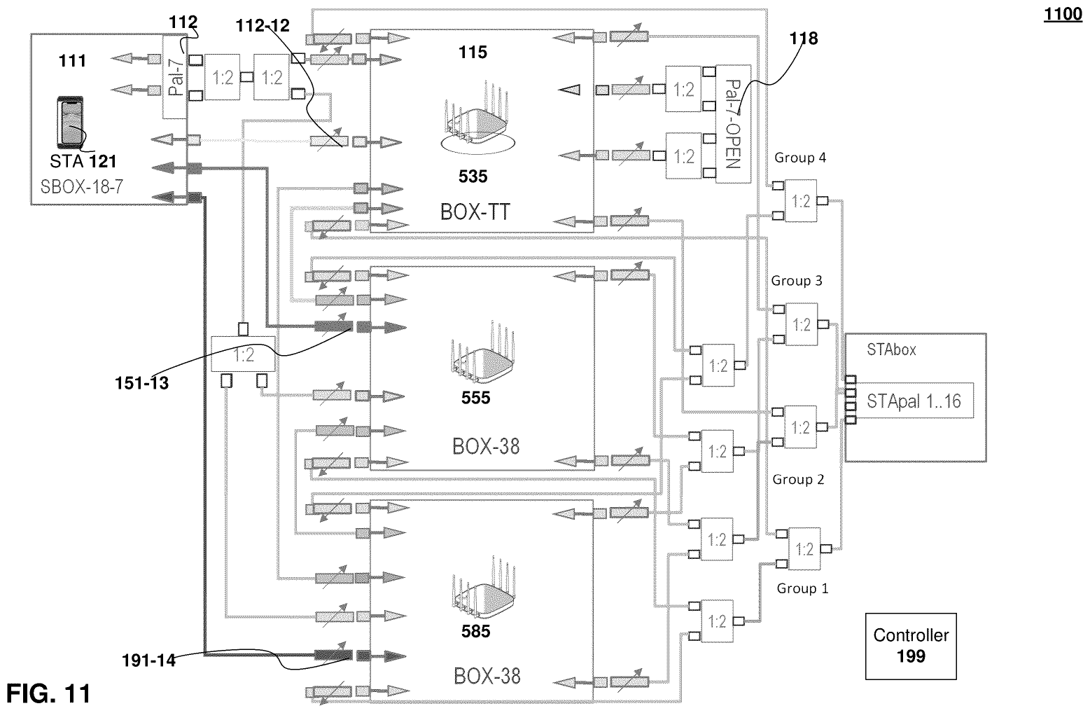

Next, FIGS. 3-10 illustrate a model home with wireless network and corresponding testbed setup for testing with an example scenario characteristic. FIG. 3 illustrates a model home with a wireless network. FIGS. 4-5 address testbed setup of the access points. FIGS. 6-9 address testbed setup of emulating stations to capture the scenario characteristic of many applications competing for bandwidth. FIGS. 10-11 address testbed setup of a moving station, and testing application traffic streams to and from the moving station.

The scenario involves many applications competing for bandwidth in the mesh network. The test involves an application executing on a wireless device that moves through the house. The moving wireless device is expected to trigger handoff between the APs in the mesh network.

FIG. 3 illustrates a floor plan of a home. Floor plan 300 shows a building that is a house with a wireless network. House 309 has a plurality of building locations, including third bedroom 321, verandah 318, master bedroom 338, dining room 365, front porch 374 and garage 388. The following description of later figures refers to these building locations to help describe setting up the testbed and performing the test with the testbed.

Building locations encompass locations associated with a building that could be reasonably planned to receive service from a wireless network. Front porch 374, for example, is attached to the building and is in close proximity with the building. Front porch 374 is a building location because a network architect could be reasonably expected to plan a wireless network to serve a wireless device on front porch 374 accessing the wireless network. A public street (not shown) south of front porch 374 is a counterexample. Although a station could conceivably gain access to the wireless network, it is unreasonable to expect a network architect to design a network for access in a public throughfare.

The building locations enumerated as part of house 309 are used when describing later figures. The enumerated building locations do not exhaust the possible building locations. The technology is operable for wireless devices or APs at any of the depicted building locations in house 309, irrespective of whether FIG. 3 provides a specific reference number for the building locations. Samplers visit actual buildings (such as house 309) with path loss test equipment in different building locations. The path loss test equipment records the path losses between pairs of building locations. A number of locations in the building can be five, eight, ten, fifteen, twenty or fifty building locations per building or in a range between any two of these counts. Additionally or alternatively, samplers can record pathlosses along paths that could be reasonably planned to receive service from the wireless network. The samplers can record paths by continuous recording, or sampling along the path. A number of paths can be one, three, five, ten paths through the house, or in a range between any two of these path counts. A testbed controller later accesses the stored model path losses during testbed calibration and testing.

A calibrated testbed replicates model path losses in a complex home or other building setup. A combination of realistic path losses and multiple wireless devices competing for bandwidth facilitates realistic testing of application Quality of Experience (“QoE”). The tests that use the stored path losses are not merely test network performance metrics, but instead test how the STAs and APs would act in a network if placed in the real home being emulated. QoE test results can be compiled using a testbed without an actual home visit to house 309. The technology can be applied to other building types, including and are not limited to office buildings, apartments, condominiums, hotels, motels, convention centers, dining establishments, and transportation hubs (e.g., airports, train stations, subway stations, etc.).

FIG. 4 illustrates the floor plan for the home with Access Points in a mesh network. Floor plan 400 shows access points (“APs”) 421, 438 and 465, RF connection segments 425, 433 and 447, and building locations introduced in FIG. 3.

The APs are part of the mesh network. AP 465 is a root AP. APs 421 and 438 are extenders. Root AP 465 is in dining room 365, and extender APs 421 and 438 are respectively located in third bedroom 321 and master bedroom 338.

The APs communicate with one another over connection 425, 433 and 447. The connections can be wireless, in a mesh network, or by ethernet cable backhaul. The APs communicate in a mesh when passing Internet traffic received at the root wirelessly via an extender to a STA and back.

Path losses between wireless network APs can affect an application's Quality of Experience (“QoE”). An application can depend on the timeliness and reliability of transiting packets. Lost or corrupted packets can require retransmission or provide poor-quality results.

The pair of APs 421 and 438 can directly exchange signals over connection 425, which is colored gold in the floor plan. Likewise, APs 421 and 465 can exchange signals over dark blue connection 433, and APs 438 and 465 can exchange signals over green connection 447.

FIG. 5 illustrates the block diagram of the testbed with Access Points emulating the mesh network in the FIG. 4 home. This figure applies color coding to FIG. 1. The testbed adjusts attenuators to emulate path loss of wireless connections between the Access Points (“APs”). Testbed diagram 500 includes APs 535, 555 and 585. Testbed diagram 500 also includes attenuators and test chambers, as introduced in FIG. 1. APs 535, 555 and 585, in second, third and fourth test chambers 115, 145 and 175, are APs connected in a mesh. Respective cables with attenuators connect the test chambers. Revisiting FIG. 4, AP 535 corresponds to root APs 465. APs 555 and 585 respectively correspond to extender APs 421 and 438 in the mesh network.

Returning now to FIG. 5, the colored cables with attenuators connecting test chambers 115, 145 and 175 correspond to the connection colors in FIG. 4. For example, the gold-colored cable configured with attenuator 161-34 in this figure corresponds to connection 425 of FIG. 4. Controller 199 adjusts attenuator 161-34 during testbed calibration. The attenuation of traffic sent between AP 555 and 585, post-adjustment, is the same attenuation that applied to signals over connection 425. Likewise, the dark blue and green colored cables FIG. 5 connect the other pairs of APs. Attenuator 141-23 reproduces the path loss of segment 433 and attenuator 181-24 reproduces the path loss of connection 447.

Tests of Quality of Experience involving APs coupled in a mesh reproduce model path losses between the APs. Emulating the wireless network to determine application QoE involves reproducing the model path losses. For example, assume a station in house 309 transmits gestural information to the cloud. Gestural information is conveyed in a traffic stream through extender AP 421 to root AP 465 over dark-blue connection 433 in house 309. The signal that carries the gestural information is subject to path loss. Likewise, in the testbed, signals carrying the gestural information testbed are transmitted by AP 555 to AP 535 over the dark-blue connective cable and are attenuated by attenuator 141-23 calibrated to reproduce a path loss that is consistent with connection 433 in the house. Delays in transferring the gestural information, caused by corrupted or lost packets or throttling of bandwidth can cause the user to perceive lag. Perceptible lag reduces the QoE in both the home and the testbed.

FIG. 6 illustrates the floor plan with a wireless device on the front porch. Floor plan 600 includes station (aka wireless device or “STA”) 674, building locations as introduced in FIG. 3 and APs as introduced FIG. 4.

STA 674 is one of the many wireless devices that are competing for bandwidth. The STA is located at front porch 374. STA 674 can be any Wi-Fi-capable station with an application accessing the internet. For example, STA 674 can be a smartphone executing Netflix, a Video on Demand (“VOD”) application.

Segments 653, 665 and 657 represent potential respective connections between APs 421, 465 and 438. Segment 653 is orange, segment 665 is sky-blue and segment 657 is grey.

Path losses between wireless network STAs and APs can affect an application's Quality of Experience (“QoE”). A video data downlink stream from a VOD service that has too many delayed or lost frames can cause choppy video, and even result in a VOD application's premature disconnection with the VOD service. Choppy video or dropped connections can degrade the user's QoE.

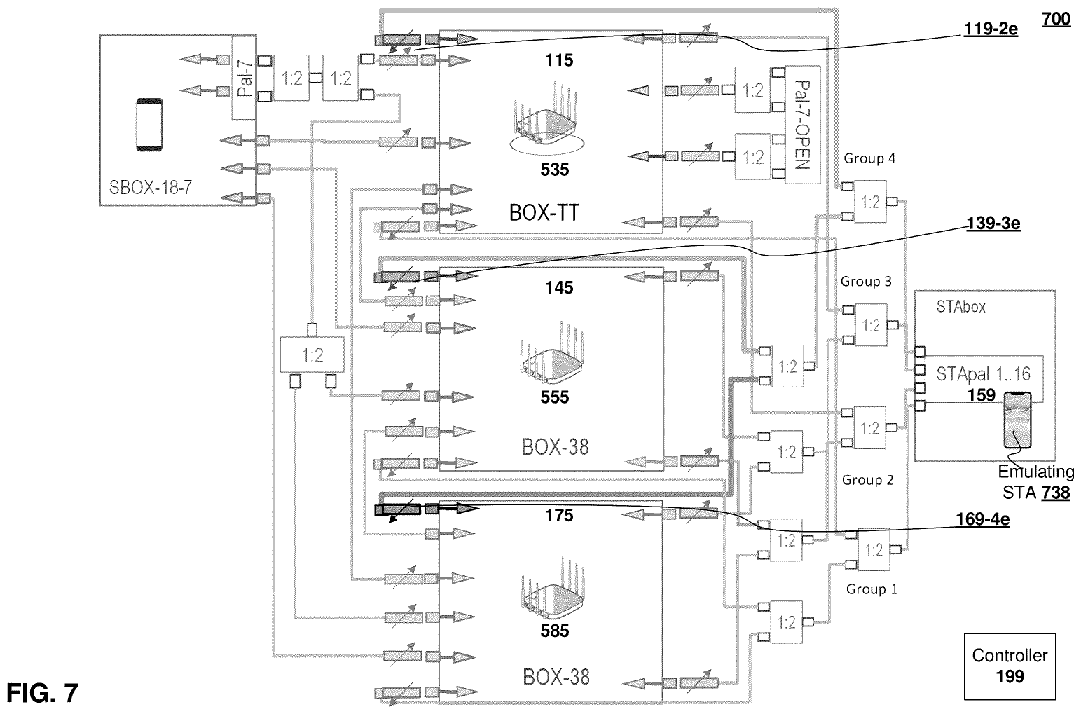

FIG. 7 illustrates the block diagram of the testbed emulating the wireless device on the front porch. Testbed diagram 700 shows emulating STA 738 being emulated by one of STApals 159. The signal is sent to at least over the splitter corresponding to group 4 to second test chamber 115, third test chamber 145 and fourth test chamber 175. This STA could be emulated by a mobile device in a test chamber (not illustrated) or by a PAL. Testbed diagram 700 also includes the STApals, test chambers and attenuators introduced in FIG. 1, and the APs introduced in FIG. 5.

The testbed emulates the respective path losses between the STApal that emulates emulating STA 738 and APs 535, 555 and 585. Revisiting FIG. 6, STA 674 is a station connected to Access Points (“APs”) over segments. Note that the segments are colored blue, orange and grey. Returning now to FIG. 7, the colored cables and attenuators 119-2e, 139-3e, and 169-4e correspond to the similarly colored segments. Controller 199 adjusts attenuator 139-3e such signal transiting between AP 555 and emulating STA 738 match the attenuation of signals transiting orange segment 653. Similarly, controller 199 adjusts attenuator 119-23 to match the path loss of segment 665 and adjusts attenuator 169-4e to match the path loss over grey segment 657.

The matched path losses enable the emulating network to react to emulating STA 738 as if it were the mesh network reacting to STA 674 on front porch 374. The attenuators attenuate the traffic exchanged between emulating STA 738 and any of APs 535, 555 and 585 to the same degree as traffic transiting through the segments in the model home.

Tests of Quality of Experience that involve the STA and one of the APs transmitting data to each other reproduce path losses between the STA and the one AP. Continuing the example of FIG. 6, STA 674 receives video frame information from AP 465 from a video traffic stream routed through AP 465 over sky-blue segment 665. The signal that carries the video information undergoes path loss. Returning to FIG. 7, signals in the testbed carrying the video information are transmitted by AP 535 to emulating STA 738 over the sky-blue connective cable and are attenuated by attenuator 119-2e. The signals transiting the sky-blue cable undergo a path loss that is consistent with the path loss over segment 665. Delays in transferring the video information, caused by corrupted or lost packets, could cause the user to perceive dropped video frames and reduce the application QoE. The Netflix or VOD QoE score reflects the reduction in QoE.

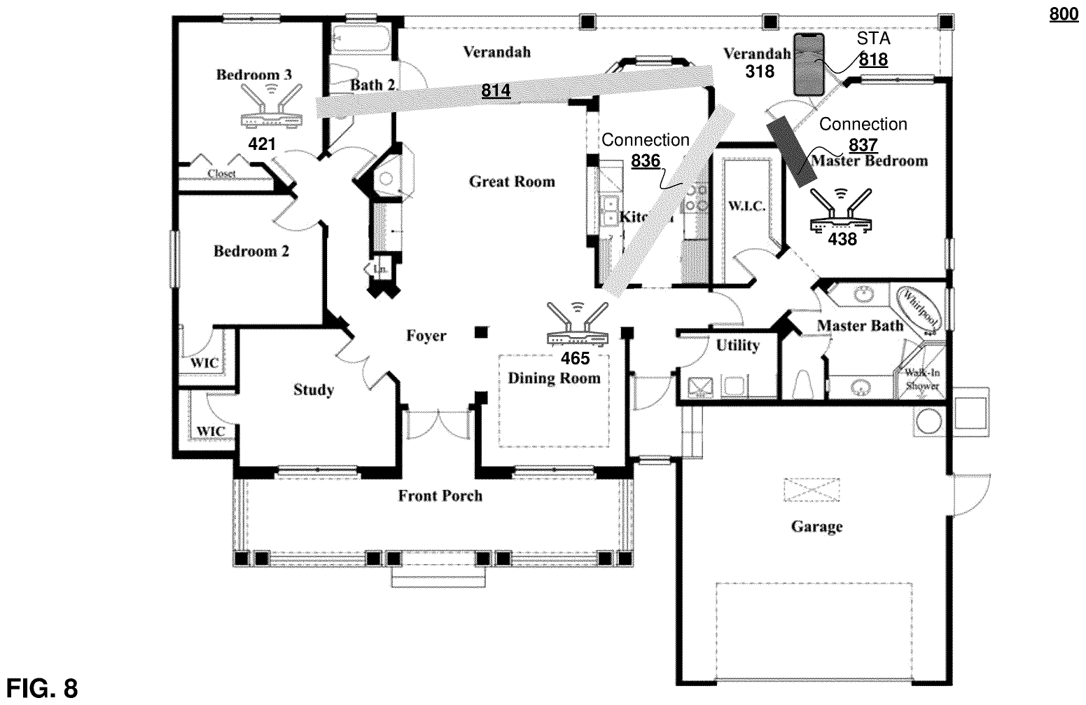

FIG. 8 illustrates the floor plan with another wireless device at verandah 318. Floor plan 800 includes station (aka wireless device or “STA”) 818, and segments 814, 836 and 837. Floor plan 800 also includes the building locations introduced in FIG. 3 and access points (“APs”) introduced in FIG. 4.

STA 818 is another one of the many STAs that are competing for bandwidth. STA 818 is located in verandah 318 and can be any station with an application accessing the internet. For example, STA 818 can be an Internet of Things (“IoT”) exterior lighting control that obtains information such as time, date, season, holidays, and current newsworthy events, and changes the verandah lighting based on the received information.

Segments 814, 836 and 837 represent potential respective connections between APs 421, 465 and 438. Segment 814 is teal-colored. Segment 836 is yellow colored. Segment 837 is red-colored.

The scenario characteristic calls for “many wireless devices,” so the reader will understand that although only two STAs have been discussed so far, the test can require the number of wireless devices to be at least sixteen, twenty, thirty, fifty, or other higher numbers. The precise minimum number can vary test-by-test. The example test, for this set of figures, determines whether a mesh network maintains a minimum video streaming Quality of Experience during handoff. The test for this set of figures involves invoking a handoff process when an AP reaches a connection capacity threshold of thirty connections to wireless devices. Thus, in the example, the minimum number corresponds to the number of wireless devices needed for the AP to reach its connection capacity threshold.

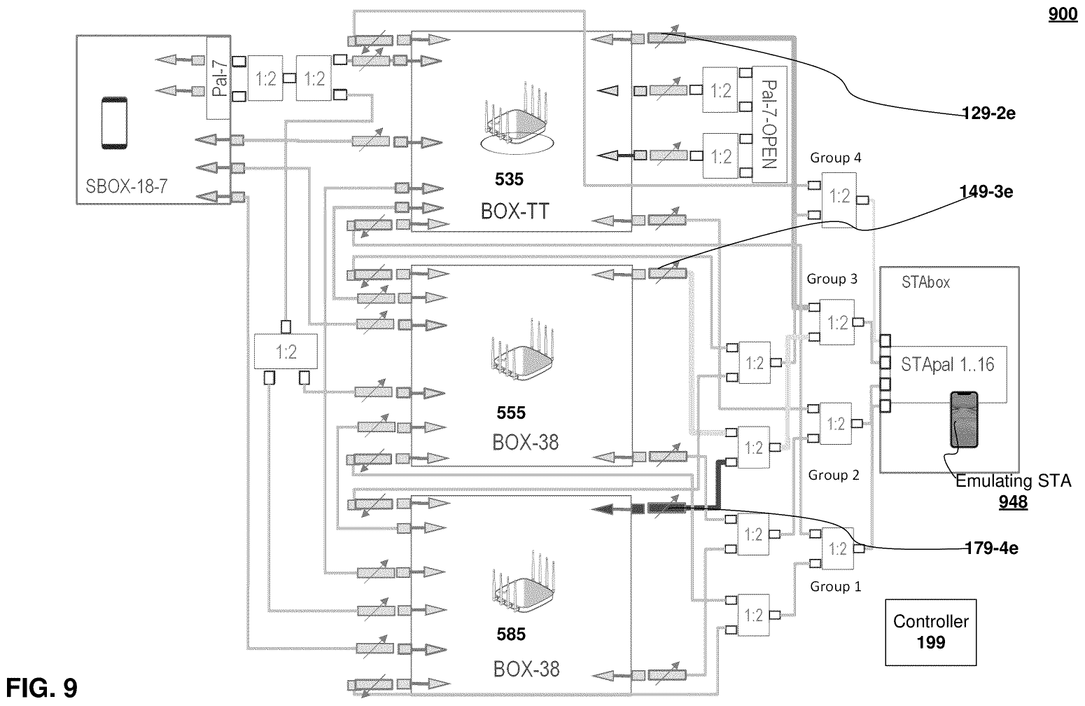

FIG. 9 illustrates the block diagram of the testbed emulating the wireless device at the verandah. Testbed diagram 900 shows emulating station (“STA”) 948 being emulated by one of STApals 159, and attenuators 129-2e, 149-3e, and 179-4. Testbed diagram 900 also includes STApals, test chambers and attenuators introduced in FIG. 1, and the APs introduced in FIG. 5.

The comparison between FIGS. 8 and 9 is similar to the comparison between FIGS. 5 and 6. Controller 199 adjusts attenuators 129-2e, 149-3e, and 179-4e such that the path losses from emulating STA 948 to the APs matches the respective path losses of the segments between STA 818 and APs 465, 421 and 438.

One difference between FIGS. 8 and 9, and FIGS. 5 and 6, is that emulating STA 948 is emulated is emulated by a STApal in group 3 rather than group 4. Although STApal groups can emulate more than one STA at a time, the test requires different building locations for STAs 674 and 818, and from the scenario requiring the STAs to compete for bandwidth. The competition requires emulating STAs 738 and 948 to generate network traffic at the same time. If controller 199 adjusted attenuators 119-2d, 139-3e and 169-4e for emulating STA 948 to generate network traffic, those attenuators would no longer be correctly adjusted for emulating STA 738. By setting up emulating STA 948 and STA 738 in separate groups, controller 199 can adjust attenuators 129-2e, 149-3e, and 179-4e, which attenuate traffic from the group 3 splitter, according to their respectively colored segments without adjusting attenuators 129-23, 139-3e, and 169-4e, which carry group 4 traffic.

The multiple groups allow testers to emulate many STA-many AP network environments, without resorting to simplifying the emulated network. The testbed controller can setup emulated STAs to simulate their presence in multiple building locations, such as the kitchen, study, and master bath, or any other building location that has stored model path losses, by calibrating the testbed in similar fashion to FIGS. 6-9.

FIG. 10 illustrates the floor plan 1000 with the mesh network serving moving wireless device (aka station or “STA”) 843 that traverses path 1077 through the home. Moving STA 1043 connects to various APs over segments 1032 (colored indigo), 1035 (colored violet) and 1064 (colored peach). The moving wireless device can have an ongoing connection with the mesh network. As the moving device changes proximity to the APs, it can trigger handoff processes.

A handoff of a wireless device between APs can involve changing the channel (frequency, time slot, spreading code, or combination of them) associated with the current connection while a communication is in progress. The handoff transfers an ongoing connection of a wireless device from a current AP to a different AP. Handoff can occur when the wireless device leaves the range of the current AP, the connection sufficiently degrades in quality, or the AP reaches a connection capacity threshold. An example of the handoff process with 802.11 devices can be summarized as follows: A wireless device tunes into predefined channels and listens for beacon frames that APs periodically send out. The wireless device creates a candidate list of APs from the beacon frames and decides with which AP to associate based on the received signal strength. The wireless device tunes into a channel and either passively scans for beacon frames or actively scans by sending a probe request to a channel, processing received Probe Response frames, and then sending a probe request to the next channel. The wireless device selects, based on the measured Signal-to-Noise ratios, the best AP in the candidate list of APs after scanning.

In FIG. 10, moving STA 1043 can be a virtual reality headset executing a VR or XR game. Moving STA 1043 traverses path 1077, starting at garage 388 and ending at master bedroom 338.

Virtual Reality is the use of computer modeling and simulation that enables a person to interact with an artificial three-dimensional (3-D) visual space and optionally include other artificial sensory perceptions such as audial and tactile perceptions. Augmented Reality (AR) is the overlay of visual depictions onto the real world. XR (eXtended Reality) encompasses augmented reality, VR, or combinations of AR and VR. Users of XR/VR software can move around the visual space. Modern XR/VR software includes the user moving about physical reality as well.

XR/VR games can have many traffic streams. An XR/VR game can have a downlink video stream to feed information to the user's headset, a user interface uplink stream that provides pose information, gesture information, or button presses to a game server for user input, a haptics downlink that provides tactile information to user equipment (e.g. gloves, shoes, bodysuit) that is equipped with kinesthetic devices for tactile feedback, game audio downlinks for game environment sounds, and both uplink and down downlink voice audio streams for user chat.

Gaming traffic streams have high-performance requirements to ensure that the user has a high-quality gaming experience. An XR/VR game with stunning visuals, crisp sound, realistic haptics, but takes over five seconds to respond to user's gestural commands can render that game nigh unplayable. Users are unlikely to have a good experience with a game they cannot play. Different streams have different requirements. A video stream to the headset may need to maintain a minimum number of Frames per Second (“FPS”) whereas there is no concept of a “frame” in audio, let alone FPS. Therefore, testing the XR/VR game involves different measurements for the video stream and for the audio stream.

Moving STA 1043 moves closer to some APs and away from others as the moving STA traverses path 1077. Moving STA 1043 moves towards the dining room through the west hall, away from root AP 465. It moves towards extender AP 421. Moving STA 1043 then moves through verandah 318 towards master bedroom 338, towards extender AP 438. Proximity to an AP can affect the connection quality. Poor connection quality can induce the STA or AP to begin the handoff process.

Path losses from the model home structure surfaces can also degrade the connection quality over a segment. For example, several walls obstruct segments 1032 and 1035 when moving STA passes dining room 365. Meanwhile, segment 1064 is unobstructed to AP 465. By contrast, after moving STA 1043 turns north into the west hall, a wall and closet interfere with traffic transiting segment 1064.

In the test, the many wireless devices competing for bandwidth can trigger handoff. The competition can result in the AP being unable to provide all of its connected STAs with sufficient bandwidth, or the number of STAs being served by an AP can reach the AP's connection capacity threshold.

FIG. 11 illustrates the block diagram of the testbed simulating the moving station. Testbed diagram 1100 shows station (“STA”) 121, introduced in FIG. 1. Testbed diagram 1100 also includes attenuators introduced in FIG. 1, and access points (“APs”) introduced in FIG. 5. Referring back to FIG. 10, moving STA 1043 corresponds to STA 121, and the colored connective cables correspond to segments 1032, 1035 and 1064. Returning now to FIG. 11, the testbed can be used to test an eXtended Reality or Virtual Reality (“XR/VR”) gaming quality of experience.

Controller 199 calibrates the testbed to simulate the respectively colored segments by adjusting attenuators 112-12, 151-13 and 191-14. These attenuators cause the respective connective cable to reproduce the path losses over respective segments 1064, 1032, 1035.

The testbed sets up a test of XR/VR Quality of Experience. Pal-7-OPEN 118 emulates a XR/VR game server running a gaming service. STA 121 starts up a VR gaming application and prepares to receive a test-initiation signal from controller 199. Controller 199 can direct the test in a stepwise fashion by sequentially providing instructions to STA 121, or the gaming application can direct the test by using a test script previously loaded on STA 121.

Controller 199 initiates the test by sending an instruction to STA 121 to generate traffic. STA 121 sends a probe request to connect to an AP, receives probe responses from the APs 535, 555 and 585, and connects to AP 535. The connection to AP 535 simulates STA 1043, located in garage 388, connecting to AP 465 over the peach-colored segment 1064.

STA 121 in first test chamber 111 exchanges traffic with Pal-7-Open 118 coupled to AP 535 in chamber 115 using the respective gaming application and gaming service. The gaming application generates traffic with the gaming service through test sequences of exchanges over video downlink traffic streams, audio downlink traffic streams, haptics downlink traffic streams, user interface uplink traffic streams (which communicates, for example, key presses or gestural information used as gaming commands), chat uplink and downlink traffic streams.

Pal-7 112 coupled to the test chamber and Pal-7-Open 118 sniff the generated traffic, including the test sequence of exchanges, and store PCAP files.

Controller 199, during the ongoing test, synchronously adjusts attenuators 112-12, 151-13 and 191-14. The adjustments simulate STA 10 moving STA 1043 moving along path 1077. The adjustment simulates movement by causing signal path losses transiting the indigo, violet, and peach-colored connective cables to reproduce the pathlosses of signals transiting respective colored segments 1032, 1035 and 1064. The gaming application and gaming server continue to generate traffic and the PALs continue to capture the generated traffic while controller 199 adjusts the attenuators to simulate movement. The captured traffic simulates XR/VR gaming traffic of a continuously moving station as opposed to just sampling traffic at predetermined sample points along path 1077.

The foregoing example testing a moving STA with the scenario characteristic of many STAs competing for bandwidth is non-limiting. Other scenario characteristics can be additional or alternative scenario characteristics. Other scenario characteristics can include, and are not limited to, big houses, many applications simultaneously using bandwidth, many Access Points, applications with high-performance demands, and sensitive applications.

The testbed supports other variations of tests. The testbed can test wireless networks with different numbers of STAs and APs. Tests can include no mobile wireless devices or many wireless devices. A tangible STA can simulate non-moving devices, and an emulating STA can simulate wireless devices. Tests practicing the technology disclosed return a QoE score for at least one STA, in a test chamber or emulated, executing an application.

Obstructions can absorb signals transiting a mesh network resulting in path losses, can reflect signals resulting in multipathing, and can delay signals resulting in phase shifting. Although this disclosure focuses on path losses in the wireless network, the testbed can account for other effects on signals besides path losses.

FIG. 12 illustrates a table of application types, traffic streams associated with those application types, and measurements of those traffic streams. (Numbers in the table are not intended to match previously described test measurements.) Table 1200 shows columns including wireless network column 1211, traffic streams column 1213 and stream measurements column 1216. Wireless network column 1211 includes sub-columns listing application types and building locations. Application type refers to different types of applications. For example, Netflix streaming is a video on demand (“VOD”) application whereas Zoom is a video conferencing application. Other application types include eXtended Reality or Virtual Reality (“XR/VR”) Gaming, VOD, video conferencing, web browsing, and mobility. The sub-column for building location refers locations in the building.

The application types imply which traffic streams are captured in PCAP files and measured to contribute to scoring. For example, the XR/VR gaming type listed in the application types sub-column implies measurement of at least traffic streams of video frames, post/button presses, haptics, and audio. By contrast, the VOD type implies measurement of a video frames traffic stream, but may not involve measurement of other traffic streams.

Data streams column 1213 includes sub-columns describing traffic streams and traffic stream parameters. The traffic streams sub-column includes traffic streams, used by the application types listed in wireless network column 1211, that are being tested. The column does not present a complete list set of traffic streams used by the application types.

A test scoring framework for an application type can be applied across different applications within the application type. For example, XR/VR applications could be used for gaming, workplace collaboration, or simple socializing. XR/VR traffic streams can include video frame traffic streams. An XR/VR Gaming type (XR/VR applications used for games) can require a throughput of at least 100 Mbps to support a 4K video frame stream with 72 Hz refresh rate. An XR/VR collaboration type (XR/VR applications used for workplace productivity enhancement) can require a more modest 30 Mbps for 1080p with 72 Hz refresh rate. A social XR/VR type (XR/VR applications used to socialize with friends) might only require a minimum of 20 Mbps.

Furthering the example, the social XR/VR application type could prioritize audio to support chat and require a higher mean throughput than the gaming type or the collaboration type but can also be more tolerant of audio delay. As a result, the social XR/VR type can require a higher average throughput for audio than the XR/VR gaming or collaboration types but set a relaxed threshold for a delay measurement.

Still furthering the example, the XR/VR gaming and collaboration types can measure user interface streams with low delay thresholds to eliminate human-perceptible lag. The social XR/VR type, in contrast, might not even measure the UI traffic stream, because user interface lag of several seconds does not provide a negative experience to casual conversation.

The traffic stream parameters sub-column includes uplink/downlink stream, mean bit rate, Variable Bit Rate (“VBR”) standard deviation, and Frames Per Second (FPS). Uplink/downlink describes whether the row represents an uplink stream (data transits primarily from application STA to server), a downlink stream (data transits primarily from server AP to application) or represents both an uplink stream and a downlink stream. Mean bit rate is the mean average bitrate of received traffic in megabits per second. VBR standard deviation is a video quality parameter. FPS is a video smoothness parameter.

Stream measurements column 1216 include measurements of traffic streams, and a normalization range for the measurement's contribution to a traffic stream score. The measurements show here are mean throughput, one way delay (“OWD”) 75^{th} percentile, OWD 90th percentile, OWD 95th percentile, OWD 99.9th percentile, effective packet loss (“EPL”) percent, bounceback, and data outage. Mean throughput is the average data throughput at the STA. The OWDs at various percentiles are measurements of packet delay. They measure the time taken for the n-th percentile of packets to reach their destination when traversing the wireless network. For example, if 75% of video frame packets take up to 3 milliseconds to travel from a root to the station executing an application, then the OWD 75th percentile is 3 milliseconds. EPL percent is the percentage of packets lost per second. Bounceback measures the responsivity of the wireless device executing the application and a server hosting the service. Data outage is a time that traffic cannot received by either the application or the service.

Each traffic stream row contains threshold values that result in minimum or maximum measurement scores. The threshold values of the measurement scores define a normalization range. The values include a number with a green background and a number with a red background. The green background value provides the favored threshold corresponding to the highest score for the measurement. The red background value provides the disfavored threshold corresponding to the lowest score for the measurement. The technique for scoring the measurements using these thresholds is described in more detail below, with reference to FIG. 13.

The rows do not provide thresholds for each measurement listed under stream measurements 1216, but only the ones applied by the test. For example, the XR/VR Gaming has a haptics downlink stream, which only measures mean throughput, OWD 90^{th} percentile, and OWD 99.9^{th} percentile. The row does not contain threshold values, for examples, related to EPL or bounceback because scoring a traffic stream for the XR/VR gaming QoE score does not require measuring EPL or bounceback.

The table serves as a demonstration of how application types, traffic streams, and measurements relate to one another. The table does not provide an exhaustive list of traffic streams, applied measurements, or thresholds. The XR/VR gaming application type, for example, contains an audio traffic stream row. A particular game can involve both chat audio and game audio. To establish a Quality of Experience for the particular game, it could be necessary to test the chat audio streams and game audio streams separately. Furthermore, these streams can have different sets of measurements applied to the stream and even different thresholds for similar measurements. The table also does not provide an exhaustive list of measurements. Tests such as round-trip time or band preference, for example, may be appropriate for some traffic streams associated with some application types even though no corresponding measurement is shown in the table.

Measurement and scoring engines can apply variations on the measurements. For example, a bounceback measurement could be a median bounceback or a maximum time bounceback.

FIGS. 13A, 13B and 13C, collectively referred to as FIG. 13, illustrate thresholded normalized scoring for two scoring measurements of One-Way Delay (“OWD”). FIG. 13 provides two examples of the process that the measurement and scoring engine obtains measurement scores. Although it is described with reference to OWD measurements, other measurements can be scored in the same manner.

FIG. 13A illustrates a cumulative distribution function plot of One-Way Delay. Cumulative distribution function plot 1300A includes X-axis 1329, Y-axis 1311, range for mean OWD 1332 and range for OWD 99.7th percentile 1337. Dashed lines indicate the mean and 99.7th percentile in the plot based on measurements.

X-axis 1329 represents the maximum time, in milliseconds, that packets take to travel between a root AP and a wireless device. Y-axis 1311 represents the number of packets, sent from the wireless device that arrived at a server. Alternatively, OWD can be measured by using packets sent from the server and arrived at the wireless device.

A range for mean OWD 1332 depicts a range from 50 to 75 milliseconds in x-axis 1329. Likewise, a range for OWD 99.7th percentile 1337 depicts a range from 100 to 120 milliseconds in X-axis 1329. The range signifies the values where the measurement score can be scaled between 0 and 1.

FIG. 13B illustrates a thresholded normalized scoring plot of mean One Way Delay. Thresholded normalized scoring plot 1300B includes x-axis 1356 and Y-axis 1344. Y-axis 1344 shows a measurement score scaled between 0 and 1. Of course, another range such as 0 to 100 could be used for scaling or a physical measurement range such as dB could be used in preliminary stages before scaling to a QoE score. X-axis 1356 shows a range of times between 30 and 80 milliseconds. The dashed line represents the measurement score as a function of time. To the right side, the favored threshold of 50 milliseconds and disfavored threshold of 75 milliseconds, first presented in FIG. 13A, are reproduced for convenience.

A measurement that falls between the two thresholds results in a score normalized to the two thresholds. Referring back to FIG. 13A, the mean OWD was measured as 67.5 milliseconds. Returning to FIG. 13B, the mean OWD was halfway between the thresholds of 50 milliseconds and 75 milliseconds. Thus, the mean OWD measurement score was normalized to 0.5. If the mean OWD value had been measured as 55 milliseconds instead of 67.5 milliseconds, the measurement score would have been normalized to 0.8.

Exceeding either of the two thresholds results in a fixed score. Exceeding the green0colored favored threshold results in a measurement score of the maximum value 1. Exceeding the red-colored disfavored threshold results in a measurement score of the minimum value 0. Therefore, if the mean OWD value had been measured at 45 milliseconds, the measurement score would have been 1, not 1.2. Likewise, if the mean OWD value had been measured at 100 ms, the measurement score would have been 0.

FIG. 13C illustrates a thresholded normalized scoring plot of One-Way Delay 99.7^{th} percentile. The illustration serves as another example of thresholded normalized scoring.

Thresholded normalized scoring plot 1300C includes x-axis 1396 and Y-axis 1374. Y-axis 1374 shows a measurement score scaled between 0 and 1. X-axis 1396 shows times in milliseconds between 80 and 125 ms. The dashed line represents the score as a function of time. To the right side, the favored threshold of 100 milliseconds and disfavored threshold of 120 milliseconds, first presented in FIG. 13A, are reproduced for convenience.

Scoring with respect to the favored and disfavored thresholds works the same way as described in FIG. 13B. As shown in FIG. 13A, the 99.7th percentile value was 115 milliseconds. Thus, the measurement score was normalized to 0.25. If the OWD 99.7th percentile value had been instead 121 milliseconds, the value would have exceeded the disfavored threshold, and the measurement score would have been the minimum value of 0. If the OWD 99.7^{th} percentile had been 99.999 milliseconds, the measurement score would have exceeded the favored threshold, and the measurement score would have been the maximum value of 1.

The measurement and scoring engine can apply thresholded normalized scoring to other measurements besides OWD. Other measurements, for example, can include throughput, bounceback, and effective packet loss percentage.

FIG. 14 illustrates a table of traffic streams associated with application types, traffic stream scoring based on measurement scores, and Quality of Experience scoring based on the traffic stream scores.

Table 1400 shows Quality of Experience (“QoE”) scoring column 1411. Table 1400 also includes the wireless network column, and the data traffic streams column introduced in FIG. 12.

QoE scoring 1411 includes sub-columns of application component scoring, application scoring and overall house scoring.

The application component scoring sub-column demonstrates that scoring for each traffic stream is a multiplicative function of the measurement scores. For example, referring back to FIG. 12, XR/VR Gaming video frames traffic stream measures mean throughput, OWD 75^{th} percentile, OWD 95^{th} percentile, and OWD 99.9^{th} percentile. The entry for application component scoring in the XR/VR video frames row shows the measurement and scoring engine determines the traffic stream score by multiplying the measurement scores associated with the traffic stream. The measurement scores are normalized score in a range of 0 to 1. The summary traffic stream score also falls within a range between 0 and 1, which can be rescaled to 0 to 100 or any other desired range.

The application component scoring sub-column shows scoring for each traffic stream is a multiplicative function of the measurement scores. Once all of the traffic streams for an application have been tested, the traffic stream scores are combined, resulting in an application QoE score. XR/VR gaming, for example, includes the traffic streams of traffic streams of video frames, pose/button presses, haptics, and audio. The measurement and scoring engine combines the traffic stream scores from the gaming application traffic stream, resulting in an XR/VR gaming QoE score. Because the example uses a multiplicative combination and traffic streams scores all fall within a range of 0 to 1, the resultant gaming QoE score also falls within a range between 0 and 1.

Application QoE scores for applications supporting transmission types sent to multiple destinations (e.g. multicasting) can be determined on a per-receiver basis. For example, devices in a bedroom, in a study, and in a library host separate instances of a security system application. Each instance subscribes to a live video stream being multicast from a security system camera. In the example, security system application QoE scores are individually determined for the application in the bedroom, the application the study, and the application the library. The QoE scores are individually determined because the experience between the different application instances can be different. The individual devices hosting the instances can be connected to different access points. Signals traveling to the individual devices can encounter different obstacles and travel over different distances leading to different pathlosses.

The measurement and scoring engine can also use the application QoE score as a building block for other scores. For example, the overall house scoring sub-column shows a building score. Applications of the different application types are executed in different building locations. The building score can be based on the multiplicative combination of application QoE scores for different application types being executed in the different building locations. Sub scores also can be combined additively and rescaled. Measurement and scoring engine can combine building scores for different model homes into an overall score.

After scoring, the application QoE score, as well as other scores such as measurement scores, traffic stream scores, and any generated building scores or scenario scores, is provided to a reporting engine. The QoE scores and other scores, if any, can be provided with or without other network information. Other network information can include routing paths, handoff event times, AP load, and any other such information that can be determined by a testbed, or from information provided by the testbed to network analytics tools.

The QoE score, and other scores, can be reported in a range of 0 to 1 or rescaled into a range of 0 to 10 or 0 to 100.

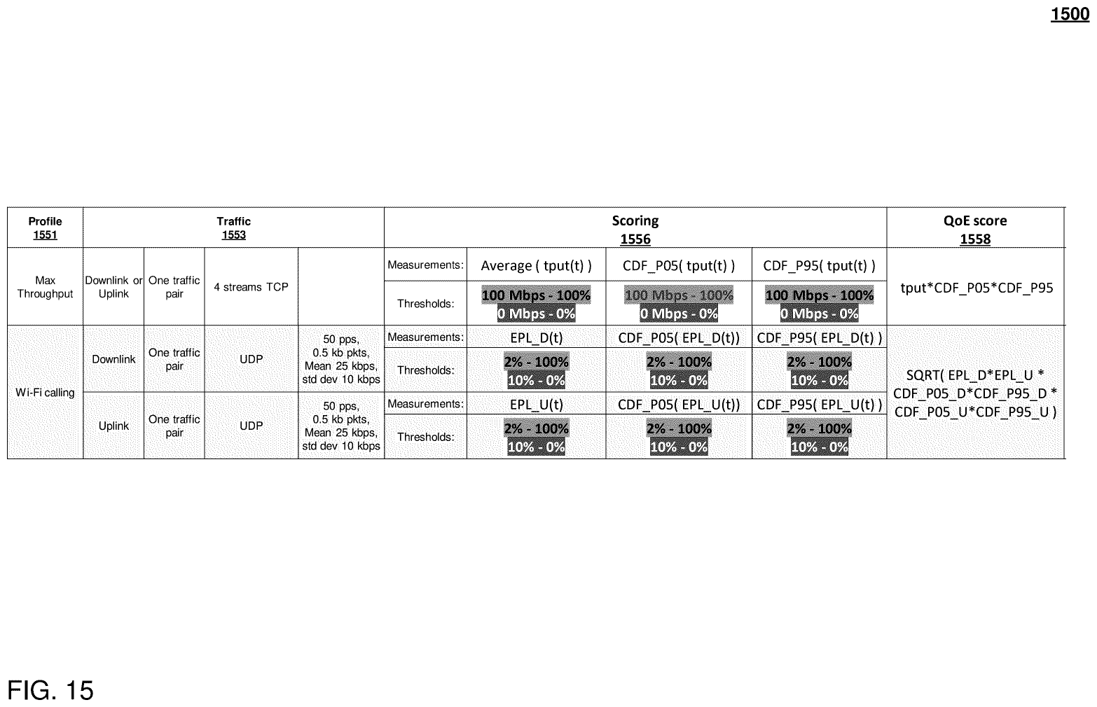

FIG. 15 illustrates a table of example canned traffic profiles, and more examples of Quality of Experience (“QoE”) scoring.

Table 1500 contains a table of columns for profile 1551, traffic 1553, scoring 1556, and final score 1558.

Profile column 1551 provides the names of canned traffic profiles that match one or more application types. Max Throughput is the name of a traffic profile that matches application types where high levels of throughput correspond to higher quality of experiences. Web browsing and email are two examples of application types where the Max Throughput profile is appropriate for generating network traffic. Wi-Fi calling is the name of a canned traffic profile for voice communication that occurs, at least in part, over the wireless network. Teamspeak and Blink are two examples of applications that where the Wi-Fi profile is appropriate for generating network traffic.

Traffic sub-column 1553 sets provides four sub-columns of uplink/downlink traffic, traffic transmission type, network protocol, and minimum transmission requirements. The uplink/downlink sub-column describes whether the row represents uplink traffic (data transits primarily from application STA to server), a downlink traffic (data transits primarily from server AP to application) or represents both uplink traffic and a downlink traffic. The max throughput profile is used to generate either uplink or a downlink traffic. The Wi-Fi calling profile is used to generate both uplink and downlink traffic.

The traffic transmission type sub-column describes whether the network traffic is sent by traffic pair (an endpoint-to-endpoint communication) by multicasting (a single point sending identical traffic to many particular endpoints), or any other type of “casting” that is appropriate for a wireless network. The network protocol sub-column provides packet types such as Transmission Control Protocol, User Datagram Protocol, Internet Control Message Protocol, Internet Group Management Protocol, raw, and other protocols. The minimum transmission requirements provide the minimum requirements for a transmission to be useful for a test, if any. The max throughput profile has no minimum requirement. The Wi-Fi calling profile has minimum requirements of 50 packets per second, 512 bytes packet size, a mean throughput of 25 kilobits per second with a standard deviation of 10 kilobits per second. The minimum requirement should not be confused with a measurement disfavored threshold. Rather, if the traffic minimum requirements are not met, the test itself may be invalid.

Scoring column 1556 provides four sub-columns: a row-label sub-column, and three measurements/threshold sub-columns. The row-label sub-column is a guide to the reader that the top-half of each measurements/threshold sub-column sets forth a measurement, and the bottom half of the row sets forth the favored threshold (highlighted in green) and disfavored threshold (highlighted in red). The three measurements for traffic generated from the throughput profile are the mean throughput, throughput 5^{th} percentile, and throughput 95^{th} percentile. The three measurements for traffic generated from the Wi-Fi calling profile are Effective Packet Loss (“EPL”), EPL 5^{th} percentile, and EPL 95^{th} percentile. A measurement engine, such as the measuring and scoring engine in FIG. 2, applies thresholded normalized scoring using the thresholds to obtain respective measurement scores.

Final score column 1558 provides how a measurement and scoring engine obtains QoE scores for the traffic. Combining scores for traffic throughput can involves multiplying measurement scores in multiplicative combination. Obtaining scores for Wi-Fi calling can involve the square root of the measurement scores. The approach to scoring Wi-Fi profile traffic can combine the results of two types of traffic into a single score.

### Computer System

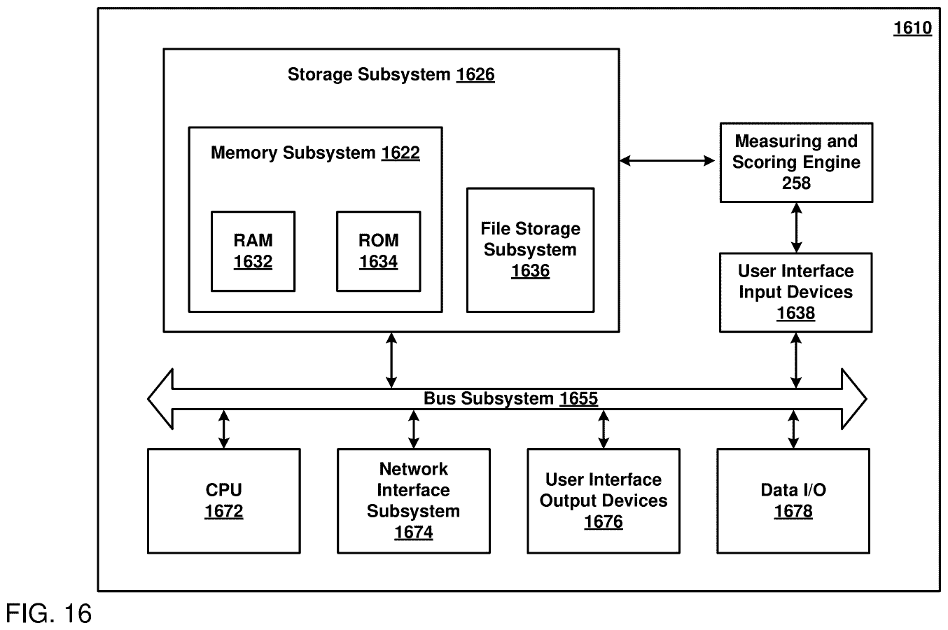

FIG. 16 is a block diagram of an example computer system, according to one implementation.

Block diagram 1600 shows a computer system that can be used to measure and score captured test sequence of exchanges from a network analyzer. Computer system 1610 includes at least one central processing unit (CPU) 1672 that communicates with a number of peripheral devices via bus subsystem 1655. These peripheral devices can include a storage subsystem 1626 including, for example, memory devices and a file storage subsystem 1636, user interface input devices 1638, user interface output devices 1676, a network interface subsystem 1674, and data I/O 1678. The input and output devices allow user interaction with computer system 1610. Network interface subsystem 1674 provides an interface to outside networks, including an interface to corresponding interface devices in a communication network with other computer systems.

In one implementation, measuring and scoring engine 258 can be communicably linked to the storage subsystem 1626 and the user interface input devices 1638. User interface input devices 1638 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 1610.

User interface output devices 1676 can include a display subsystem, a printer, a fax machine, or non-visual displays such as audio output devices. The display subsystem can include an LED display, a cathode ray tube (CRT), a flat-panel device such as a liquid crystal display (LCD), plasma, organic light-emitting diode (OLED), a projection device, or some other mechanism for creating a visible image. The display subsystem can also provide a non-visual display such as audio output devices. In general, use of the term “output device” is intended to include all possible types of devices and ways to output information from computer system 1610 to the user or to another machine or computer system.

Storage subsystem 1626 stores programming and data constructs that provide the functionality of some or all of the modules and methods described herein.

Memory subsystem 1622 used in the storage subsystem 1626 can include a number of memories including a main random-access memory (RAM) 1634 for storage of instructions and data during program execution and a read only memory (ROM) 1632 in which fixed instructions are stored. A file storage subsystem 1636 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 1636 in the storage subsystem 1626, or in other machines accessible by the processor.

Bus subsystem 1655 provides a mechanism for letting the various components and subsystems of computer system 1610 communicate with each other as intended. Although bus subsystem 1655 is shown schematically as a single bus, alternative implementations of the bus subsystem can use multiple busses.

Computer system 1610 itself can be of varying types including a personal computer, a portable computer, a workstation, a computer terminal, a network computer, a television, a mainframe, a server farm, a widely distributed set of loosely networked computers, or any other data processing system or user device. Due to the ever-changing nature of computers and networks, the description of computer system 1610 depicted in FIG. 16 is intended only as a specific example for purposes of illustrating the preferred embodiments of the present invention.

Many other configurations of computer system 1610 are possible having more or less components than the computer system depicted in FIG. 16.

### Particular Implementations

Some particular implementations and features are described in the following discussion.

In one implementation, a by a testbed, of scoring a Quality of Experience (“QoE”) of applications connected to an internet by emulating, in a testing environment, a mesh network of devices at building locations inside of a building as a model network. The testbed includes a controller and test environment devices. The testing environment includes a plurality of test environment devices comprising test chambers holding respective wireless devices that run applications or Access Points (“APs”), respective connective cables between pairs of test environment devices and respective attenuators on the respective connective cables, and at least one of the APs coupled to a server outside of the testbed.

The method of scoring the QoE involves starting the wireless devices and causing the wireless devices to connect to one of the APs in the mesh network.

The method of scoring also involves a controller accessing a traffic profile associated with the wireless devices at the building locations and invoking applications of multiple types on the wireless devices and causing the applications to generate wireless traffic.

The method involves, according to the traffic profile, including executing test sequences of exchanges with the server. Optionally, at least one of the application types is a gaming application that uses three or more traffic streams selected from stream types consisting of a video frames downlink stream, a user interface uplink stream, a haptics downlink stream, a chat audio streams and a game audio downlink stream. The method also includes measuring traffic produced by the test sequences of exchanges. Measuring the gaming application includes data throughput of each of the three or more traffic streams and a distribution of packet delays for each of the three or more traffic streams. The method also involves scoring the traffic streams measured for each of the test sequences of exchanges. Scoring the gaming application combines the measured data throughput and a plurality of packet delay lengths from the distribution of packet delays into traffic stream scores. The method also includes combining multiple traffic stream scores for the gaming application to produce a gaming QoE score. The method also includes reporting the gaming QoE score.

This method in other implementations of the technology disclosed can include one or more of the following features and/or features described in connection with additional methods disclosed. In the interest of conciseness, the combinations of features disclosed in this application are not individually enumerated and are not repeated with each base that of features. The reader will understand how features identified in this section can readily be combined with sets of these features identified as implementations.

In some implementations, the testing environment configures the attenuators such that a path loss between a pair of wireless devices in the testing environment reproduces the path loss between the wireless devices at the respective building locations. In further implementations, the method can also include reconfiguring the attenuators to emulate a second wireless network at second building locations inside a second building. In these implementations, the method also includes repeating the starting, accessing, causing, measuring and scoring in the second wireless network at the second building locations inside the second building to obtain second QoE scores. And in these implementations, the method can also include reporting a scenario score based on at least the QoE scores and the second QoE scores.

In some implementations, the plurality of test environment devices further include an emulator that emulates a wireless device.

In some implementations, the method can include reporting parameters of a test sequence of exchanges, the parameters comprising at least mean bit rate.

In some implementations, the method can include determining packet paths traversed by the test sequence of exchanges over the model network, to or from the wireless device executing the gaming application. In these implementations, the method can also include reporting the packet paths traversed.

In further implementations, the method can include determining, using the packet paths and measured throughputs, traffic loads through the APs in the mesh. In these implementations, the method can include reporting the determined traffic loads for the APs.

In some implementations, the method can further include measuring traffic loads at the test environment devices corresponding to APs. In these implementations, the method can also include reporting the measured traffic loads.

In some implementations, scoring the traffic streams comprises applying thresholded normalized scoring to the measurement. The thresholded normalized scoring includes: Falling between favored and disfavored thresholds results in a measurement score that is proportionally scaled to minimum and maximum measurement scores. Exceeding the disfavored threshold of a thresholded normalized scoring results in a minimum measurement score. And exceeding the favored threshold of the thresholded normalized scoring is scored at a maximum measurement score.

In some implementations, the model network includes simulating movement of one of the STAs as a roaming STA by adjusting, over time, the attenuators on the connective cables between a test chamber holding the one STA.

In another implementation, a disclosed system includes one or more processors coupled to memory, the memory loaded with computer instructions, when executed on the processors, implement any of the disclosed methods.

In yet another implementation a disclosed tangible non-transitory computer readable storage medium is impressed with computer program instructions that, when executed on a processor, implement any of the disclosed methods.

The technology disclosed can be practiced as a system, method, or article of manufacture. One or more features of an implementation can be combined with the base implementation. Implementations that are not mutually exclusive are taught to be combinable. One or more features of an implementation can be combined with other implementations.

While the technology disclosed is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the innovation and the scope of the following claims.

We claim as follows:

1. A method, by a testbed, of scoring a Quality of Experience (“QoE”) of applications connected to an internet by emulating, in a testing environment, a wireless mesh network of devices at building locations inside of a model building, wherein the testing environment includes
a plurality of test environment devices comprising test chambers holding respective wireless devices that run applications, Access Points (“APs”), and emulators,
respective connective cables between pairs of test environment devices and respective attenuators on the respective connective cables,
at least two of the APs coupled in a mesh, and
at least one of the APs serving as a gateway coupled to an emulated or cloud-based server;
the method of scoring the QoE of a gaming application comprises:
starting the wireless devices and APs, and causing the wireless devices to connect to the mesh;
a controller
accessing a traffic profile associated with the wireless devices at the building locations and invoking applications of multiple types on the wireless devices, and
causing the applications to generate wireless traffic according to the traffic profile, including executing test sequences of exchanges with the server;
wherein the gaming application uses three or more traffic streams selected from stream types consisting of a video frames downlink stream, a user interface uplink stream, a haptics downlink stream, a chat audio uplink and downlink streams and a game audio downlink stream;
measuring traffic produced by the test sequences of exchanges
wherein measuring traffic of the gaming application includes data throughput of each of the three or more traffic streams and a packet delay distribution for each of the three or more traffic streams;
scoring the traffic streams measured for each of the test sequences of exchanges;
wherein scoring the gaming application combines the measured data throughput and a plurality of delay lengths from the packet delay distribution into traffic stream scores;
combining multiple traffic stream scores for the gaming application to produce a gaming QoE score; and
reporting the gaming QoE score.

2. The method of claim 1, wherein the testing environment configures the attenuators such that a path loss between a pair of wireless devices in the testing environment reproduces the path loss between the wireless devices at the respective building locations.

3. The method of claim 2, further comprising:
producing QoE scores for other applications in the wireless network;
combining the QoE scores to produce a building score;
reconfiguring the attenuators to emulate a second wireless network at second building locations inside a second model building; and
repeating the starting, accessing, causing, measuring and scoring in the second wireless network at the second building locations inside the second building to obtain second application QoE scores and a second building score; and
reporting a scenario score based on at least the building score and the second building score.

4. The method of claim 1, further comprising:
producing QoE scores for other applications in the wireless network;
combining the QoE scores to produce a building score.

5. The method of claim 1, further comprising reporting parameters of a test sequence of exchanges, the parameters comprising at least mean bit rate.

6. The method of claim 1, further comprising:
determining packet paths traversed by the test sequence of exchanges over the wireless network, to or from the wireless device executing the gaming application; and
reporting the packet paths traversed.

7. The method of claim 6, further comprising:
determining, using the packet paths and measured throughputs, traffic loads through the APs in the mesh;
reporting the determined traffic loads for the APs.

8. The method of claim 1, further comprising
measuring traffic loads at the test environment devices corresponding to APs; and
reporting the measured traffic loads.

9. The method of claim 1, wherein scoring the traffic streams comprises applying thresholded normalized scoring to the distribution of packet delays, the thresholded normalized scoring comprising:
falling between favored and disfavored thresholds results in a measurement score that is proportionally scaled to maximum and minimum measurement scores;
exceeding the disfavored threshold of thresholded normalized scoring results in the minimum measurement score;
exceeding the favored threshold of thresholded normalized scoring results in the maximum measurement score.

10. The method of claim 1, wherein emulating the wireless mesh network includes simulating movement of the wireless device running the gaming application within the model building by adjusting, over time, the attenuators on the connective cables between a test chamber holding the wireless device running the gaming application and the test chambers holding the APs.

11. A method, by a testbed, of scoring a Quality of Experience (“QoE”) of applications connected to an internet by emulating, in a testing environment, a wireless mesh network of devices at building locations inside of a model building, wherein the testing environment includes
a plurality of test environment devices comprising test chambers holding respective wireless devices that run applications, Access Points (“APs”), and emulators,
respective connective cables between pairs of test environment devices and respective attenuators on the respective connective cables, and
at least two of the APs coupled in a mesh;
at least one of the APs serving as a gateway coupled to an emulated or cloud-based server;
the method of scoring the QoE of a video conferencing application comprises:
starting the wireless devices and APs, and causing the wireless devices to connect to the mesh of APs;
a controller
accessing a traffic profile associated with the wireless devices at the building locations and invoking applications of multiple types on the wireless devices, and
causing the applications to generate wireless traffic according to the traffic profile, including executing test sequences of exchanges with the server;
wherein the video conferencing application uses three or more traffic streams selected from stream types consisting of video frames uplink and downlink streams, audio uplink and downlink streams and a user interface uplink stream;
measuring traffic produced by the test sequences of exchanges;
wherein measuring traffic of the video conferencing application includes data throughput of each of the three or more traffic streams and a packet delay distribution for each of the three or more traffic streams;
scoring the traffic streams measured for each of the test sequences of exchanges;
wherein scoring the video conferencing application combines the measured data throughput and a plurality of delay lengths from the packet delay distribution into traffic stream scores;
combining multiple traffic stream scores for the video conferencing application to produce a video conferencing QoE score; and
reporting the video conferencing QoE score.

12. The method of claim 11, wherein the testing environment configures the attenuators such that a path loss between a pair of wireless devices in the testing environment reproduces the path loss between the wireless devices at the respective building locations.

13. The method of claim 12, further comprising:
producing QoE scores for other applications in the wireless network;
combining the QoE scores to produce a building score;
reconfiguring the attenuators to emulate a second wireless network at second building locations inside a second model building; and
repeating the starting, accessing, causing, measuring and scoring in the second wireless network at the second building locations inside the second building to obtain second application QoE scores and a second building score; and
reporting a scenario score based on at least the building score and the second building score.

14. The method of claim 11, further comprising:
producing QoE scores for other applications in the wireless network;
combining the QoE scores to produce a building score.

15. The method of claim 11, further comprising reporting parameters of a test sequence of exchanges, the parameters comprising at least mean bit rate.

16. The method of claim 11, further comprising:
determining packet paths traversed by the test sequence of exchanges over the wireless network, to or from the wireless device executing the video conferencing application; and
reporting the packet paths traversed.

17. The method of claim 16, further comprising:
determining, using the packet paths and measured throughputs, traffic loads through the APs in the mesh;
reporting the determined traffic loads for the APs.

18. The method of claim 11, further comprising
measuring traffic loads at the test environment devices corresponding to APs; and
reporting the measured traffic loads.

19. The method of claim 11, wherein scoring the traffic streams comprises applying thresholded normalized scoring to the distribution of packet delays, the thresholded normalized scoring comprising:
falling between favored and disfavored thresholds results in a measurement score that is proportionally scaled to maximum and minimum measurement scores;
exceeding the disfavored threshold of a thresholded normalized scoring results in the minimum measurement score;
exceeding the favored threshold of the thresholded normalized scoring results in the maximum measurement score.

20. The method of claim 11, wherein the wireless network includes simulating movement of the wireless device running the video conferencing application within the model building by adjusting, over time, the attenuators on the connective cables between a test chamber holding the wireless device running the video conferencing application and the test chambers holding the APs.
